(19) United States
(12) Patent Application Publication
(10) Pub. No.: US 2007/0081062 A1
(43) Pub. Date: Apr. 12, 2007

(54) Ink set and inkjet image recording method

(75) Inventors: Satoshi Higuchi, Kanagawa-ken (JP); Toshiyuki Makuta, Shizuoka-ken (JP); Shigetomo Tsujihata, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/540,556

(22) Filed: Oct. 2, 2006

(30) Foreign Application Priority Data
Sep. 30, 2005 (JP) 2005-288902

(51) Int. Cl. G01D 11/00

(52) U.S. Cl. 347/100

(57) ABSTRACT

The present invention provides an ink set including multiple liquids including at least first and second liquids, wherein the first liquid contains a hydrophobic polymer, and the hydrophobic polymer includes at least a unit represented by the following formula (1), wherein R¹ represents a hydrogen atom or an alkyl group that may have a substituent group; R² represents an alkyl or aryl group that may have a substituent group; and L represents a linking group selected from the group consisting of —C(═O)O—, —O—, and —OC(═O)—.

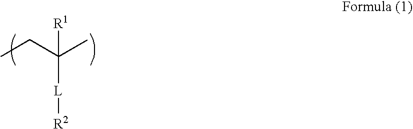

### CROSS-REFERENCE TO RELATED APPLICATION

This application claims priority under 35 USC 119 from Japanese Patent Application No. 2005-288902, the disclosure of which is incorporated by reference herein.

### BACKGROUND OF THE INVENTION

1. Field of the Invention

The present invention relates to an ink set and an inkjet image recording method. Specifically, the invention relates to an ink set which is used for an inkjet image recording method by multi-liquid aggregation and to an inkjet image recording method allowing formation of a high-quality image.

2. Description of the Related Art

Inkjet systems have been used in many printers because the system can be configured with a compact and inexpensive device and because images can be formed on recording media in a non-contact manner. In inkjet systems, ink is ejected from an ink-ejecting opening such as a nozzle. Among inkjet systems, piezo-inkjet systems and thermal-inkjet systems enable high resolution and high speed printing. The piezo-inkjet systems utilize deformation of piezoelectric elements to eject ink and the thermal-inkjet systems utilize boiling of ink caused by application of thermal energy to eject ink.

Currently, it has become important to increase the processing speed and improve the image quality during printing on plain paper or non-water-absorbing recording media such as plastics by inkjet printers. In particular, prolonged drying time for droplets after printing causes practical problems such as a tendency for image bleeding to occur. And not only does interference between ejected droplets due to intermixing between adjacently ejected ink droplets occur, thereby inhibiting formation of sharp images, it is also necessary to dry the printed media without stacking immediately after printing because the solvent drying speed is extremely low when non-water-absorbing recording media are used.

As a method for promoting curing of ink for preventing image bleeding and line width broadening and for improving the quality of solid image, proposed were inkjet inks that were cured and fixed not by evaporation of an ink solvent but by radiation ray (e.g., Japanese Patent Application Laid-Open (JP-A) No. 5-214279). However, these inkjet inks, which used a pigment dispersion as a colorant component, often resulted in nozzle clogging because of aggregation of the pigment, making it difficult to eject the ink stably.

For that reason, an UV-curable ink using a dye as a colorant was also disclosed, for forming an image superior in transparency and color tone without use of pigment (e.g., U.S. Pat. No. 4,303,924). However, the ink often unfavorably polymerized during storage, causing a problem of insufficient storage stability. The ink also contained conductive salts that could be less soluble in the ink, causing a concern about the printing defect due to precipitation of the salts during long-term storage.

Methods of using a two-liquid type ink and allowing the two liquids to react on a recording medium are proposed for improvement in both storage stability and drying speed. Examples of such methods include a method of applying a liquid containing a basic polymer and then an ink containing an anionic dye (e.g., JP-A No. 63-60783), a method of applying a liquid composition containing a cationic substance and then an ink containing an anionic compound and a colorant (e.g., JP-A No. 8-174997), and a recording method of using two inks, one containing a photo-curable resin and the other containing a photopolymerization initiator (e.g., Japanese Patent No. 3478495).

However, these methods, which are aimed at suppressing image bleeding by precipitation of the dye itself, cannot sufficiently avoid deterioration in image quality that is caused by interference between ejected droplets.

In inkjet recording, ink (liquid) droplets n1, n2, n3, . . . , nx are sequentially ejected onto a recording medium forming a line or image, and the “interference between ejected droplets” is a phenomenon wherein adjacently ejected droplets (e.g., the droplets n1 and n2) fuse with each other in order to reduce surface energy (reduce surface area). When the adjacent droplets fuse with each other, the positions of the droplets are shifted from the initial ejected positions, causing unevenness of line width especially when thin lines are drawn with colorant-containing ink. In addition, the ejected ink liquid tends to diffuse on the recording medium over time, and the dot diameter undesirably increases when the period until curing by activation light is elongated, causing a problem of broadening of the dot-formed line (line width broadening). The method of applying a liquid containing a basic polymer and then an anionic dye-containing ink (e.g., JP-A No. 63-60783) was lower in drying speed because the liquid contained an aqueous solvent, and also caused a concern about deterioration in image quality due to the uneven distribution of the precipitated dye on a recording medium.

### SUMMARY OF THE INVENTION

The present invention has been made in view of the above circumstances and provides an ink set and inkjet image recording method.

A first aspect of the invention provides an ink set comprising multiple liquids including at least first and second liquids, wherein the first liquid contains a hydrophobic polymer, and the hydrophobic polymer comprises at least a unit represented by the following formula (1):

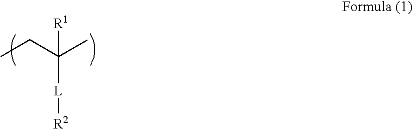

wherein R¹ represents a hydrogen atom or an alkyl group that may have a substituent group; R² represents an alkyl or aryl group that may have a substituent group; and L represents a linking group selected from the group consisting of —C(═O)O—, —O—, and —OC(═O)—.

A second aspect of the invention provides an inkjet image-recording method using the ink set according to the first aspect, comprising applying the first and second liquids simultaneously or sequentially in either order onto a recording medium to form an image.

### DETAILED DESCRIPTION OF THE INVENTION

The ink composition according to the invention is an ink composition containing a hydrophobic polymer, the hydrophobic polymer comprising at least a unit represented by the following formula (1):

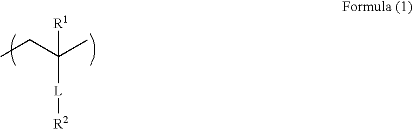

In the formula (1), R¹ represents a hydrogen atom or an alkyl group that may have a substituent group; R² represents an alkyl or aryl group that may have a substituent group; and L represents a linking group selected from the group consisting of —C(═O)O—, —O—, and —OC(═O)—.

The ink set according to the invention is an ink set comprising multiple liquids including at least first and second liquids, wherein the first liquid contains a hydrophobic polymer having at least a unit represented by the formula (1).

The ink set according to the invention (hereinafter, referred to simply as “ink set” in some cases) is favorably used as an inkjet-recording ink set. The first liquid preferably contains substantially no colorant. In addition, the second liquid preferably contains a colorant; at least one of the multiple liquids preferably contains a polymerizable compound (in the present specification, polymerizable materials and crosslinkable materials are collectively called “polymerizable compounds”); and the second liquid preferably contains the polymerizable compound.

By using the first liquid containing substantially no colorant but containing a hydrophobic polymer having at least a unit represented by the formula (1) and the second liquid containing a colorant, it is possible to effectively prevent bleeding, line width broadening and tackiness, and improve abrasion resistance.

In the invention, it is also preferable to add a polymerization (crosslinking) initiator for curing the polymerizable compound to at least one of the multiple liquids used in the image-recording method (including the first and second liquids), from the viewpoint of obtaining superior fixability. The polymerization initiator is preferably added to the liquid containing no polymerizable compound, from the viewpoint of liquid storage stability.

In the invention, when the multiple liquids contain a low-boiling point organic solvent (boiling point: 100° C. or lower) as a solvent, curability of the liquids may be affected. Presence of a water-soluble solvent in the solvent may result in prolonged evaporation time, i.e., low evaporation speed. For the reasons above, it is preferable to prepare the multiple liquids without use of such solvents.

The inkjet image-recording method according to the invention (hereinafter, referred to simply as “image-recording method” in some cases) is an inkjet image-recording method using the ink set according to the invention including multiple liquids including at least the first and second liquids, the method comprising applying the first and second liquids simultaneously or sequentially in either order onto a recording medium to form an image.

In the image-recording method, at least one of the multiple liquids contains a polymerizable compound, and an image is formed by applying the first and second liquids simultaneously or sequentially in either order onto a recording medium.

When applying the first and second liquids onto the recording medium, it is more preferable to eject the second liquid onto the recording medium by an inkjet nozzle simultaneously with or after application of the first liquid onto the recording medium, for prevention of bleeding, line width broadening and tackiness, and improvement of abrasion resistance.

The present invention will be described in detail below, in which the ink composition according to the invention will be first described, and the components for the multiple liquids will be then described.

<<Ink Composition>>

<Hydrophobic Polymer>

The ink composition according to the invention contains a hydrophobic polymer having at least a unit represented by the following formula (1): 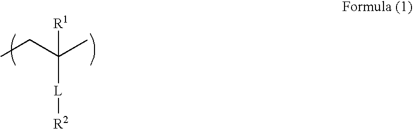
(R¹ represents a hydrogen atom or an alkyl group that may have a substituent group; R² represents an alkyl or aryl group that may have a substituent group; and L represents a linking group selected from the group consisting of —C(═O)O—, —O—, and —OC(═O)—).

The ink composition according to the invention contains at least the compound represented by the formula (1) and preferably contains a polymerization initiator and a high-boiling point organic solvent as needed. These compounds will be described below. The ink composition according to the invention may suitably be used as the first liquid for use in the ink set according to the invention. That is, the ink composition according to the invention can be used favorably in inkjet recording application.

In the formula (1) above, R¹ represents a hydrogen atom or an alkyl group that may have a substituent group. The number of carbons in the alkyl group is preferably 1 to 12, more preferably 1 to 6, and particularly preferably 1 to 4. Favorable examples of the alkyl group include methyl, ethyl, n-propyl, i-propyl, n-butyl, t-butyl, n-hexyl, n-octyl, n-decyl, n-dodecyl, hydroxymethyl, methoxymethyl, and methylcarbonyloxy group, and the like. R¹ is particularly preferably a hydrogen atom.

In the formula (1) above, R² represents an alkyl or aryl group that may have a substituent group. The alkyl group and aryl group may have a substituent group, and examples of the substituent group include halogen atoms, aryl, alkoxyl, aryloxy, acyloxy group, and alkoxycarbonyl groups, and the like; and among them, aryl, alkoxy, and acyloxy group are preferable. The number of the carbons in the alkyl group is preferably 1 to 32, more preferably 2 to 24, and particularly preferably 4 to 18. Specific favorable examples of the alkyl groups include methyl, ethyl, n-propyl, i-propyl, n-butyl, t-butyl, n-hexyl, n-octyl, 2-ethylhexyl, n-decyl, n-dodecyl, octadecyl, benzyl, hydroxyethyl, hydroxybutyl, methoxyethyl, ethoxyethyl, 2-chloroethyl, 3-chloropropyl, acetoxyethyl, acetoxybutyl, phenyloxyethyl, phenyloxybutyl, and phenylethyloxyethyl group, and the like; and n-butyl, t-butyl, n-hexyl, n-octyl, 2-ethylhexyl, n-decyl, and n-dodecyl group are particularly preferable.

The number of the carbons in the aryl group is preferably 6 to 32, more preferably 6 to 24, and particularly preferably 6 to 18. Specific examples of the aryl group include phenyl, naphthyl, 2-methoxyphenyl, 2-decyloxyphenyl, 4-methoxyphenyl, 2-octyloxynaphthyl, dimethylaminophenyl, 2-dodecylthiophenyl, 4-(4-methylphenylthioxy)phenyl, 2-methoxy-4-dodecylthioxyphenyl, 2-phenoxyethoxyphenyl, 2-dodecyloxyphenyl, 2-octadecyloxyphenyl, 2,5-dibenzyloxyphenyl, and 2,5-dicyclohexylmethyloxyphenyl group.

In the formula (1) above, L represents a linking group selected from the group consisting of —C(═O)O—, —O—, —OC(═O)—. Among them, L is particularly preferably —C(═O)O—.

In the invention, the polymer having the unit represented by the formula (1) is a hydrophobic polymer. The polymer is preferably dissolved in the first liquid, when the composition is used in the ink set described above. Thus, the ink composition according to the invention can suitably be used as the first liquid in the ink set according to the invention.

This is because the first liquid preferably contains no low-boiling point organic solvent (boiling point: 100° C. or lower) or water-soluble solvent. The term “hydrophobic” means that the polymer has a solubility in water of 5 mass % or less, preferably 2 mass % or less. Specifically, when the hydrophobic polymer according to the invention is mixed in 100 g of water, the solubility 24 hours after the mixing is 5 mass % or less, preferably 2 mass % or less under a condition at a temperature of 25° C. and a pressure of 1.0 Pa.

The hydrophobic polymer according to the invention preferably has an inorganicity/organicity ratio (I/O ratio) according to the organic conceptual diagram of 1 or less, more preferably 0.6 or less, and particularly 0.4 or less. The inorganicity/organicity ratio (I/O ratio) is a parameter representing a degree of hydrophilicity/hydrophobicity of a compound or a substituent group, which is described in detail in “Organic conceptual diagram” (Yoshio Koda, Sankyo Shuppan (1984)), the disclosure of which is totally incorporated herein by reference. “I” represents inorganicity, “O” represents organicity, and a larger I/O ratio means larger inorganicity (higher polarity and higher hydrophilicity).

In the polymer having the unit represented by the formula (1) according to the invention, R² is preferably a group having an inorganicity according to the “Organic conceptual diagram” (Yoshio Koda, Sankyo Shuppan (1984)) of less than 70, more preferably less than 60, and particularly preferably less than 40. R² having an inorganicity of less than 70 can effectively reduce the molecular interaction between the polymers to decrease the viscosity of an ink set.

The hydrophobic polymer according to the invention may be a copolymer of a unit represented by the formula (1) and another copolymerizable monomer. Examples of the copolymerizable monomer include (meth)acrylic esters (e.g., methyl(meth)acrylate, ethyl(meth)acrylate, and phenyl(meth)acrylate), aromatic vinyl compounds [styrene, vinyltoluene, α-methylstyrene, etc.], allyl esters [allyl acetate etc.], halogen-containing monomers [vinylidene chloride, vinyl chloride etc.], olefins [ethylene, propylene, etc.], and the like.

The weight-average molecular weight of the hydrophobic polymer is preferably, approximately 1,000 to 500,000, more preferably 2,000 to 100,000, and particularly preferably 5,000 to 50,000. A polymer having a molecular weight of less than 1,000 may lead to insufficient prevention of line width broadening and tackiness, and insufficient abrasion resistance, while a polymer having a molecular weight of more than 500,000 may lead to deterioration in handling, and consequently to ink nozzle clogging in an inkjet system.

Examples of the hydrophobic polymer favorably used in the invention include the following compounds (A-1 to C-10).

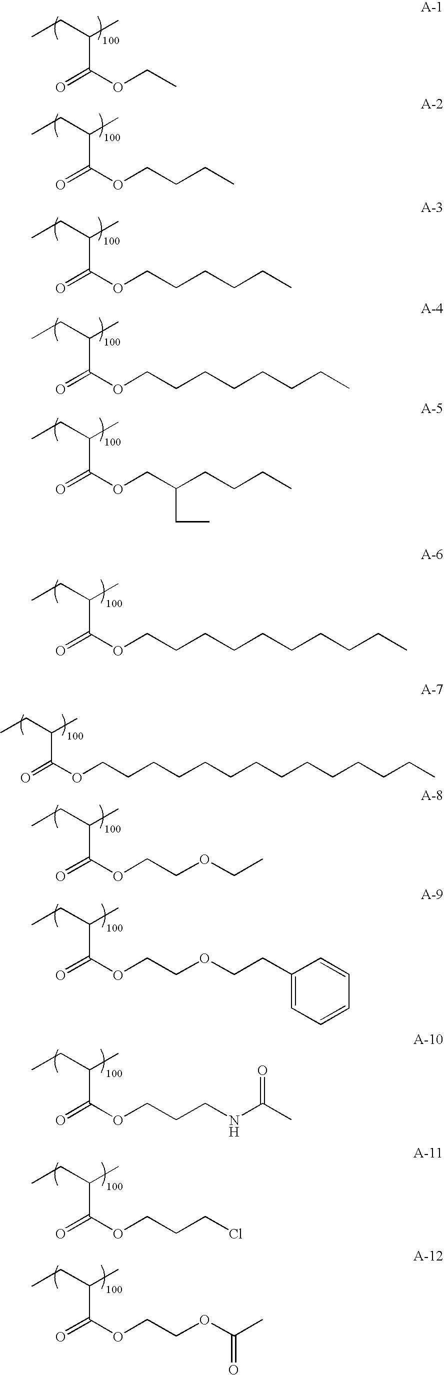

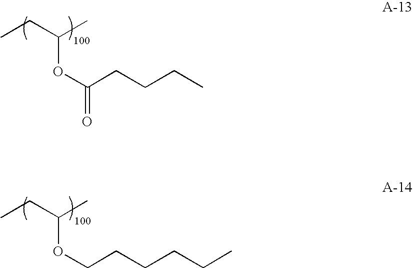

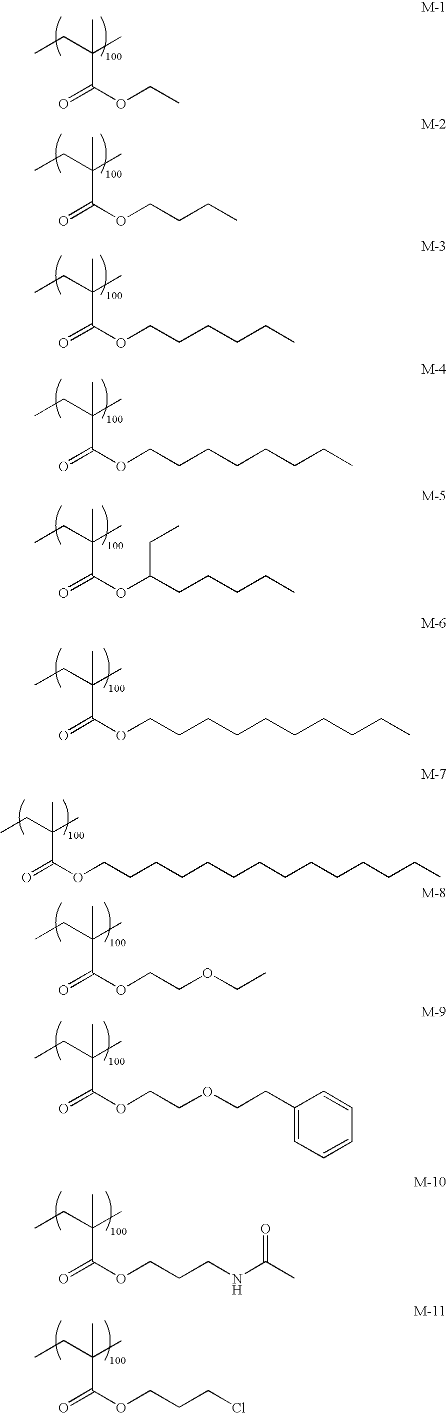

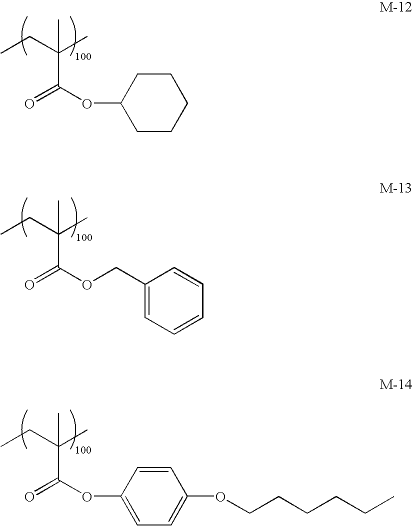

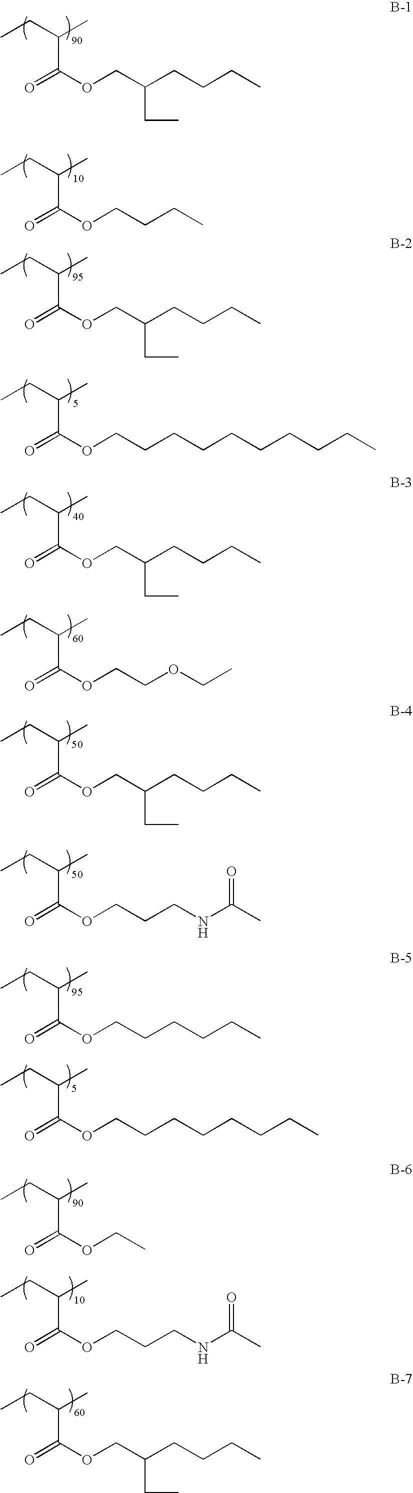

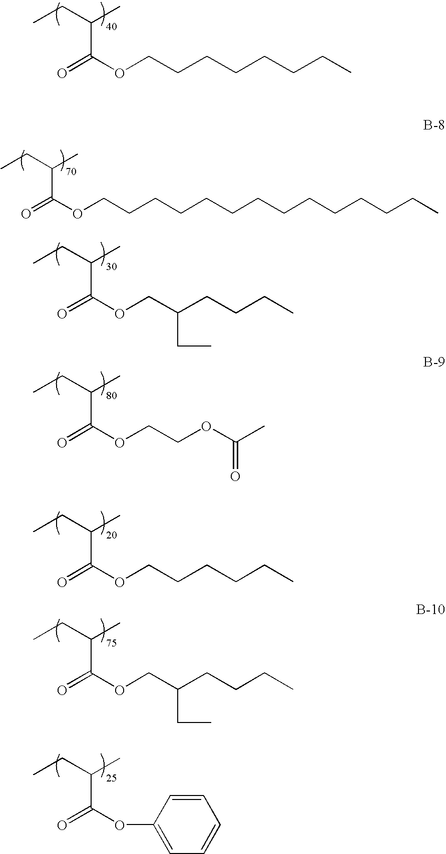

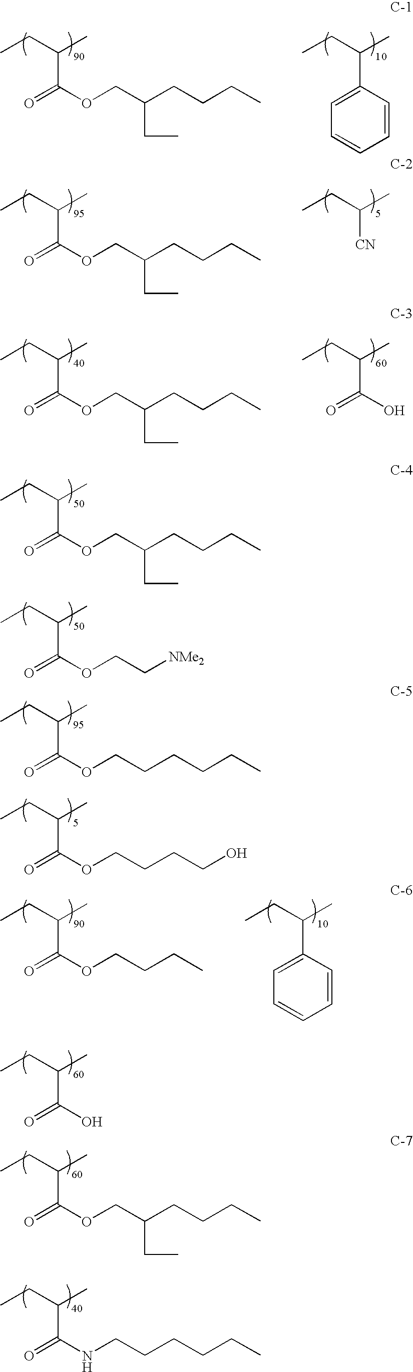

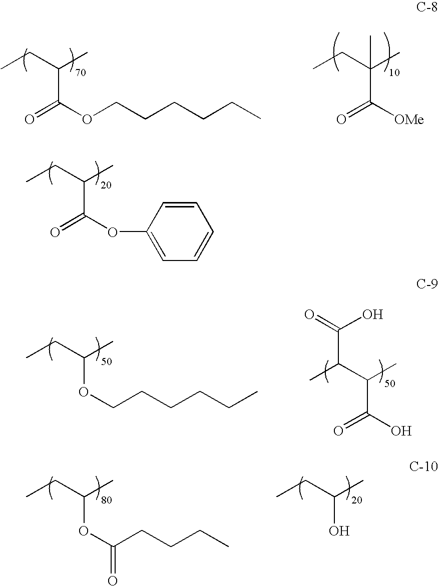

As described above, when the ink composition according to the invention is used as the first liquid of the ink set according to the invention, the hydrophobic polymer according to the invention is contained at least in the first liquid, and may further be contained in a liquid other than the first and second liquids among the multiple liquids.

The amount of the hydrophobic polymer according to the invention is preferably 1 to 90 mass %, more preferably 1 to 75 mass %, and particularly preferably 1 to 20 mass %, with respect to the entire liquid containing the hydrophobic polymeric compound (ink composition according to the invention). An amount of the hydrophobic polymer smaller than the range above may lead to insufficient advantageous effect of the invention, while an excessive amount may lead to increase in viscosity, causing a problem in ink-ejection.

<<Ink Set>>

As described above, the ink set according to the invention is an ink set comprising multiple liquids including at least first and second liquids, wherein the first liquid contains a hydrophobic polymer having at least a unit represented by the formula (1).

In a favorable embodiment of the ink set according to the invention, the first liquid contains no colorant but contains a hydrophobic polymer according to the invention, and the second liquid contains substantially no hydrophobic polymer according to the invention but contains a colorant. By using the first and second liquids satisfying the condition above, it is possible to effectively prevent bleeding and line width broadening, and provide an image having suppressed tackiness and superior abrasion resistance.

The phrase “containing substantially no hydrophobic polymer according to the invention” does not exclude presence of the polymer in an amount so as not to impair the advantageous effects of the invention, and thus, the specific content of the hydrophobic polymer according to the invention is preferably 0 to 10 mass %, more preferably 0 to 5 mass %, still more preferably 0 to 1 mass %, and particularly preferably 0 to 0.1 mass %, with respect to the total amount of the second liquid.

The hydrophobic compound is preferably contained at least in the first liquid, and may be contained in a liquid other than the first and second liquids among the multiple liquids.

<Colorant>

In a favorable embodiment of the ink set according to the invention, as described above, the first liquid preferably contains substantially no colorant but contains a hydrophobic polymer according to the invention, and the second liquid contains a colorant.

The phrase “the first liquid contains substantially no colorant” does not exclude presence of a transparent and colorless dye or pigment, or a colorant in an extremely small invisible trace amount. Specifically, the content of the colorant in the first liquid may be such that the solution absorbance at the maximum absorption wavelength of the first liquid at a thickness of 1 cm is 0 to 0.5, preferably 0.1 or less, and particularly preferably 0.01 or less.

The “absorbance” is a value calculated according to the following formula, when the intensities of the light before and after passing through the solution are designated respectively as I₀ and I.
Absorbance=log(I₀/I)

The absorbance varies according to the thickness of the cell for test solution, and thus, an absorbance of a solution having a thickness of 1 cm is used as the value.

The colorant may be contained in a liquid other than the first and second liquids. However, the other liquid containing the colorant preferably contains no polymer such as the hydrophobic compound according to the invention similarly to the second liquid, for prevention of bleeding, line width broadening and tackiness and improvement in abrasion resistance,

The colorant for use in the invention is not particularly limited, and any known water-soluble dyes, oil-soluble dyes and pigments may be appropriately selected and used, as long as they can give a color tone and a color density suitable for ink. In particular, the liquid according to the invention for the ink set is preferably a water-insoluble liquid containing no aqueous solvent, from the viewpoints of ink ejection stability and drying speed. From the same viewpoints, an oil-soluble dye or pigment, which is readily uniformly dispersed and dissolved in water-insoluble liquid, is preferably used as the colorant, and a pigment is particularly preferably used.

(Oil-Soluble Dye)

The oil-soluble dye usable in the invention is not particularly limited, and may be an arbitrarily selected oil-soluble dye. Examples of oil-soluble dyes usable in the invention are described below for respective hues.

Examples of yellow dyes include: aryl azo dyes having coupling components selected from phenols, naphthols, anilines, pyrazolones, pyridones, and open-chain active methylene compounds; heteryl azo dyes having coupling components selected from phenols, naphthols, anilines, pyrazolones, pyridones, and open-chain active methylene compounds; azo methine dyes having open-chain active methylene compounds as coupling components; methine dyes such as benzylidene dyes and monomethine oxonol dyes; quinone dyes such as naphthoquinone dyes and anthraquinone dyes; quinophthalone dyes; nitro dyes; nitroso dyes; acridine dyes; and acridinone dyes.

Examples of magenta dyes include: aryl azo dyes having coupling components selected from phenols, naphthols, and anilines; heteryl azo dyes having coupling components selected from phenols, naphthols, and anilines; azo methine dyes having coupling components selected from pyrazolones and pyrazolotriazoles; methine dyes such as arylidene dyes, styryl dyes, melocyanine dyes, and oxonol dyes; carbonium dyes such as diphenylmethane dyes, triphenylmethane dyes, and xanthene dyes; quinone dyes such as naphthoquinone, anthraquinone, and anthrapyridone; and condensed-ring polycyclic dyes such as dioxazine dyes.

Examples of cyan dyes include: indoaniline dyes; indophenol dyes; azo methine dyes having pyrrolotriazoles as coupling components; polymethine dyes such as cyanine dyes, oxonol dyes, and melocyanine dyes; carbonium dyes such as diphenylmethane dyes, triphenylmethane dyes, and xanthene dyes; phthalocyanine dyes; anthraquinone dyes; arylazo dyes having coupling components selected from phenols, naphthols, and anilines; heterylazo dyes having coupling components selected from phenols, naphthols, and anilines; indigo dyes; and thioindigo dyes.

Each of the above dyes may be a dye which shows yellow, magenta, or cyan only after dissociation of a part of the coloring atomic group (chromophore); in this case, the counter-cation may be an inorganic cation such as an alkali metal or ammonium, or an organic cation such as pyridinium or a quaternary ammonium salt, or a polymer cation having such an inorganic or organic cation as a partial structure.

The content of an oil-soluble dye in the second liquid, when the oil-soluble dye is used as a colorant, is preferably in the range of 0.05 to 20 mass %, more preferably 0.1 to 15 mass %, and still more preferably, 0.2 to 6 mass %, as solid matter. Alternatively, the content of the oil-soluble dye in the liquid other than the first and second liquids is preferably in the range of 0 to 1 mass % as solid matter in the liquid.

(Pigment)

Use of a pigment as the colorant is also favorable, because it causes aggregation more easily when multiple liquids are mixed.

Both organic and inorganic pigments may be used as the pigments for use in the invention, but the black pigment is preferably, for example, a carbon black pigment or the like. Pigments in black and three primary colors, cyan, magenta, and yellow, are commonly used, but a pigment in other color, for example, red, green, blue, brown, white or the like, a metalescent pigment, for example, in gold or silver in color, a colorless or pale-colored extender pigment, or the like may be used according to applications.

Alternatively, particles comprising a core material of silica, alumina, or resin particle and a dye or pigment bound to the surface thereof, insoluble dye lakes, colored emulsions, colored latexes, and the like may also be used as the pigments.

Yet alternatively, resin-coated pigments may also be used. These so-called microcapsulated pigments are commercially available, for example, from Dainippon Ink and Chemicals, Inc. and Toyo Ink Mfg. Co., Ltd.

The volume-average particle diameter of the pigment particles contained in the liquid in the invention is preferably 10 to 250 nm, more preferably 50 to 200 nm, from the viewpoint of the balance of the optical density and the storage stability. The volume-average particle diameter of the pigment particles can be measured by a measuring instrument such as LB-500 manufactured by Horiba Ltd.

The content of a pigment in the second liquid when the pigment is used as a colorant is preferably in the range of 0.1 to 20 mass %, more preferably 1 to 10 mass %, as solid matter, from the viewpoints of optical density and ejection stability. Alternatively, the content of the pigment, when contained in a liquid other than the first and second liquids, is preferably in the range of 0 to 1 mass % as solid matter in the liquid.

The colorants may be used alone or in combination of two or more. The colorants in different liquids may be the same as or different from each other.

<Polymerizable Compound>

In the invention, at least one liquid among the multiple liquids including the first and second liquids preferably contains a polymerizable or crosslinkable meterial (polymerizable compound). More preferably, the second liquid contains the polymerizable compound. The polymerizable compound has a function to react and cure in the polymerization or crosslinking reaction initiated by the radicals generated from the polymerization initiator described below.

Any known polymerizable compounds that polymerize in a radical or cationic polymerization reaction, a dimerization reaction, or the like may be used as the polymerizable compound. Examples thereof include addition-polymerizable compounds having at least one ethylenically unsaturated double bond, epoxy compounds, oxetane compounds, oxirane compounds, polymeric compounds having a maleimide group as a side chain, polymeric compounds having a cinnamyl, cinnamylidene or chalcone group or the like having a photodimerizable unsaturated double bond close to an aromatic ring as a side chain, and the like; addition-polymerizable compounds having at least one ethylenically unsaturated double bond are more preferable; and compounds selected from those having at least one terminal ethylenically unsaturated bond, more preferably two or more terminal ethylenically unsaturated bonds (monofunctional or multifunctional compounds) are particularly preferable. Specifically, the polymerizable compound is selected from compounds widely known in the art, and such compounds include those in various chemical forms, for example, monomers, prepolymers such as dimer, trimer and oligomer, or the mixtures thereof, and the copolymers thereof.

The polymerizable compound preferably has a polymerizable group such as an acryloyl group, a methacryloyl group, an allyl group, a vinyl group, or an internal double bond group such as maleic acid. The polymerizable group is more preferably an acryloyl group or a methacryloyl group since a compound having an acryloyl group or a methacryloyl group can be cured with low energy.

The polyfunctional polymerizable compound usable in the invention may be selected from: vinyl-group-containing aromatic compounds; (meth)acrylic esters formed by combinations of (meth)acylic acid and alcohols having at least two hydroxyl groups; (meth)acrylamides formed by combinations of (meth)acrylic acid and amines having di- or higher-valency; esters formed by combinations of polybasic acids and dihydric alcohols; polyester(meth)acrylates formed by introduction of (meth)acylic acid to polycaprolactones; polyether(meth)acrylates formed by introduction of (meth)acrylic acid to ethers obtained by combining alkyleneoxides with polyhydric alcohols; epoxy(meth)acrylates obtained by introduction of (meth)acrylic acid to epoxy resins or by reaction of di- or higher-hydric alcohols with epoxy-containing monomers; urethane acrylates having urethane bonds; amino resin acrylates; acrylic resin acrylates; alkyd resin acrylates; spiran resin acrylates; silicone resin acrylates; products of reaction of unsaturated polyesters with the above-described photopolymerizable monomers; and products of reaction of waxes with the above-described polymerizable monomers. In a preferable embodiment, the polyfunctional polymerizable compound is selected from: (meth)acrylates; polyester(meth)acrylates; polyether(meth)acrylates; epoxy acrylates; urethane acrylates; acrylic resin acrylates; silicone resin acrylates; and products of reaction of unsaturated polyesters with the above-described photopolymerizable monomers. In a more preferable embodiment, the polyfunctional polymerizable compound is selected from: acrylates; polyester acrylates; polyether acrylates; epoxy acrylates; and urethane acrylates.

In this specification, the term “(meth)acrylic acid” refers to acrylic acid or methacrylic acid or both.

Specific examples of the polyfunctional polymerizable compound include: divinylbenzene; 1,3-butanediol diacrylate; 1,6-hexanediol diacrylate; pentaerythritol triacrylate; trimethylolpropane triacrylate; dipentaerythritol hexaacrylate; 1,6-acryloylaminohexane; hydroxypivalic acid ester neopentylglycol diacrylate; polyester acrylates in which (meth)acryloyl groups are attached to terminals of molecular chains of polyesters formed by a dibasic acid and a dihydric alcohol, the polyesters having a molecular weight in the range of 500 to 30000; polyethyleneglycol diacrylates; epoxy acrylates having skeletons selected from bisphenol A, bisphenol S, and bisphenol F and having molecular weights in the range of 450 to 30000; epoxy acrylates having phenol-novolac resin skeletons and having molecular weights in the range of 600 to 30000; products of reaction of (meth)acrylic acid monomers having hydroxyl groups with polyvalent isocyanates having molecular weights in the range of 350 to 30000; and modified products of urethanes having urethane bonds in the molecule.

The monofunctional polymerizable monomer usable in the invention may be a (meth)acrylate, styrene, acrylamide, a vinyl-group-containig monomer (such as a vinyl ester, a vinyl ether, or an N-vinylamide), or (meth)acrylic acid, preferably a (meth)acrylate, acrylamide, a vinyl ester, or a vinyl ether, more preferably a (meth)acrylate or acrylamide. Such polymerizable monomers may have a substituent group. The substituent group may be a halogen atom, a hydroxyl group, an amide group, or a carboxylic acid group.

Specific examples of the monofunctional polymerizable monomer include: hydroxyethyl acrylate; glycidyl acrylate; tetrahydrofurfuryl acrylate; dicyclopentenyl acrylate; 2-acryloyloxyethyl phosphate; allyl acrylate; N,N-dimethylaminoethyl acrylate; N,N-dimethylacrylamide; N,N-diethylaminopropylacrylamide; N-butoxymethylacrylamide; acryloyl morpholine; 2-hydroxyethylvinyl ether; N-vinylformamide; N-vinylacetamide; 2-cyclohexylcarbamoyloxyethyl acrylate; acrylates each having a polybutyl acrylate moiety in the ester portion; and acrylates each having a polydimethylsiloxane moiety in the ester portion.

The polymerizable compounds may be used alone or in combination of two or more.

The content of the polymerizable compound, when contained in one or more of the multiple liquids, is preferably in the range of 20 to 98 mass %, more preferably 40 to 95 mass %, and still more preferably 50 to 90 mass %, as solid matter in the total liquids.

<Polymerization Initiator>

As described above, in the ink set of the invention, at least one of the multiple liquids (including the first and second liquids) used preferably contains a polymerization initiator that cures the polymerizable compound by polymerization or crosslinking. The polymerization initiator is preferably contained in a liquid containing substantially no polymerizable or crosslinkable material from the viewpoint of the storage stability of the liquid, and the initiator and the polymerizable compound cause a polymerization (crosslinking)-curing reaction as they are activated by the energy added onto the recording medium.

The polymerization initiator for use in the invention is a compound that generates polymerization-initiating species such as radical by the energy of light, heat, or both, and initiates and accelerates polymerization or crosslinking of the polymerizable compound. A compound suitably selected from known thermal polymerization initiators, compounds having a smaller bond dissociation energy, photopolymerization initiators, or the like is used as the polymerization initiator according to the invention.

Examples of the radical generators include organic halogenated compounds, carbonyl compounds, organic peroxide compounds, azo polymerization initiators, azide compounds, metallocene compounds, hexaarylbiimidazole compounds, organic boric acid compounds, disulfonic acid compounds, onium salt compounds, and the like.

Preferable examples of the polymerization initiator in the invention include the following photopolymerization initiators: acetophenone derivatives, benzophenone derivatives, benzyl derivatives, benzoin derivatives, benzoin ether derivatives, benzyldialkylketal derivatives, thioxanthone derivatives, acylphosphine oxide derivatives, metal complexes, p-dialkylaminobenzoic acid, azo compounds, and peroxide compounds. As the polymerization initiator, preferable are acetophenone derivatives, benzyl derivatives, benzoin ether derivatives, benzyldialkylketal derivatives, thioxanthone derivatives, and acylphosphine oxide derivatives. Still more preferable are acetophenone derivatives, benzoin ether derivatives, benzyldialkylketal derivatives and acylphosphine oxide derivatives.

Specific examples of the photopolymerization initiator include acetophenone, 2,2-diethoxyacetophenone, p-dimethylaminoacetophenone, p-dimethylaminopropiophenone, benzophenone, p,p′-dichlorobenzophenone, p,p′-bisdiethylaminobenzophenone, Michler's ketones, benzyl, benzoin, benzoin methyl ether, benzoin isopropyl ether, benzoin-n-propyl ether, benzoin isobutyl ether, benzyl dimethyl ketal, 1-hydroxy-cyclohexyl phenyl ketone, tetramethylthiram monosulfide, thioxanthone, 2-chlorothioxanthone, 2,4-dimethylthioxanthone, 2,2-dimethylpropionyl diphenylphosphine oxide, 2-methyl-2-ethylhexanoyl diphenylphosphine oxide, 2,6-dimethylbenzoyl diphenylphosphine oxide, 2,6-dimethoxybenzoyl diphenylphosphine oxide, 2,4,6-trimethylbenzoyl diphenylphosphine oxide, bis(2,6-dimethoxybenzoyl)-2,4,4-trimethylpentylphosphine oxide, 2,3,6-trimethylbenzoyl-diphenylphosphine oxide, bis(2,3,6-trimethylbenzoyl)-phenylphosphine oxide, 2,4,6-trimethoxybenzoyl-diphenylphosphine oxide, 2,4,6-trichlorobenzoyl diphenylphosphine oxide, 2,4,6-trimethylbenzoyl naphtylphosphonate, bis(η5-2,4-cyclopentadiene-1-yl)-bis(2,6-difluoro-3-(1H-pyrrole-1-yl)-phenyl)titanium, p-dimethylaminobenzoic acid, p-diethylaminobenzoic acid, azobisisobutyronitrile, 1,1′-azobis(1-acetoxy-1-phenylethane), benzoin peroxide, and di-tert-butyl peroxide.

Other preferable examples of the photopolymerization initiator include the photopolymerization initiators disclosed in Seishi Kato “Shigaisen Kouka System” (UV curing system) published by Sougou Gijutsu Center Co., Ltd (currently Extensive Technology Service Co.,Ltd) (1989), pp. 65-148, the disclosure of which is incorporated herein by reference.

The sensitivity of the polymerization initiator is preferably high. From the viewpoint of storage stability, it is not preferable to use a polymerization initiator which thermally decomposes, for example at 80° C. or lower. Accordingly, it is preferable to select a polymerization initiator which does not thermally decompose at 80° C. or lower.

Only a single polymerization initiator may be used, or two or more polymerization initiators may be used in combination. The polymerization initiator may be used together with a known sensitizer for the purpose of improving the sensitivity, as long as the effects of the invention can be achieved.

The polymerization initiator is preferably contained in a liquid other than the liquid containing the polymerizable compound. The content of the polymerization initiator in the liquid is preferably 0.5 to 20 mass %, more preferably 1 to 15 mass %, and particularly preferably 3 to 10 mass %, from the view points of stability over time, curability and curing rate. Too high content of the polymerization initiator is not preferable because precipitation or separation in the liquid over time may occur and because properties such as strength or abrasion resistance of the cured ink may be deteriorated.

<Inkjet-Recording Ink Set>

The ink set according to the invention includes multiple liquids including at least the first and second liquids (inks) described above. In a favorable embodiment, the multiple liquids according to the invention are preferably those including at least a first liquid containing substantially no colorant but containing the hydrophobic polymer according to the invention and a second liquid containing a colorant, wherein at least one of the multiple liquids contains a polymerizable compound.

Examples of the combination of the first and second liquids include:

(1) a first liquid containing a hydrophobic polymer according to the invention and a polymerizable compound, and a second liquid containing a colorant;

(2) a first liquid containing a hydrophobic polymer according to the invention, and a second liquid containing a colorant and a polymerizable compound; and

(3) a first liquid containing a hydrophobic polymer according to the invention and a polymerizable compound, and a second liquid containing a colorant and a polymerizable compound.

In each of the combinations (1) to (3) above, the first liquid and/or the second liquid preferably further contain a polymerization initiator, and in such a case, the polymerization inhibitor is preferably contained in the liquid containing no polymerizable compound in the embodiment (1) or (2), from the viewpoint of storage stability.

When three or more liquids are used, a polymerization initiator may be contained in the first liquid and/or the second liquid, or in the third liquid and not in the first liquid and/or the second liquid. Alternatively, a polymerization initiator may be contained in the first liquid and/or the second liquid as well as the third liquid.

<Other Components>

In addition to the components above, the multiple liquids according to the invention may further contain, depending on applications, the following additives.

(High-Boiling Point Organic Solvent)

In the invention, any one or more of the multiple liquids may contain a high-boiling point organic solvent that has (1) a viscosity of 100 mPa·s or less at 25° C. or 30 mPa·s or less at 60° C. and (2) a boiling point of higher than 100° C.

Addition of the high-boiling point organic solvent is effective in preventing bleeding, line width broadening and tackiness, and improving abrasion resistance.

For further prevention of bleeding and line width broadening, the high-boiling point organic solvent is preferably contained in a liquid containing no polymerizable compound.

A high-boiling point organic solvent that satisfies neither of the viscosity conditions in (1) is more viscous, often resulting in problems in application of the liquid onto a recording medium. On the other hand, a high-boiling point organic solvent not satisfying the boiling-point condition in (2) has an excessively lower boiling point, and may lead to rapid evaporation during image formation and consequently to no advantageous effects of the invention of preventing bleeding and line width broadening. In addition, evaporation and release of the organic solvent into air should be prevented form the environmental viewpoint.

Among the conditions in (1), the viscosity at 25° C. is preferably 70 m Pa·s or less, more preferably 40 m Pa·s or less, and particularly preferably 20 m Pa·s or less. The viscosity at 60° C. is more preferably 20 m Pa·s or less and particularly preferably 10 m Pa·s or less. Alternatively, the boiling point condition in (2) is preferably 150° C. or higher and particularly preferably 170° C. or higher. Further, the high-boiling point organic solvent preferably has a melting point of 80° C. or lower and preferably has a water solubility (25° C.) of 4 g or less. The water solubility is more preferably 3 g or less, still more preferably 2 g or less, and particularly preferably 1 g or less.

The “viscosity” in the invention is that determined by the following method.

The viscosity is a value determined by using RE80 Viscometer manufactured by Toki Sangyo Co., Ltd. The RE80 viscometer is a conical rotor/flat plate viscometer corresponding to E-type viscometer, the rotor used in measurement normally has rotor code No. 1, and the rotational frequency is 10 rpm. However, for measurement of a liquid having a viscosity of higher than 60 m Pa·s, the rotational frequency is changed to 5, 2.5, 1, or 0.5 as needed.

The “water solubility” in the invention is the saturated concentration of water in the high-boiling point organic solvent at 25° C., i.e., the mass (g) of water soluble in 100 g of the high-boiling point organic solvent at 25° C.

The amount of the high-boiling-point organic solvent added to the liquid is preferably in the range of 50 to 100 mass %, more preferably 70 to 100 mass %, and particularly preferably 90 to 100 mass %, with respect to the total mass of the liquid.

The amount of the high-boiling point organic solvent used in the ink set of the invention is preferably 5 to 2,000 mass %, more preferably, 10 to 1,000 mass %, as the amount coated, with respect to the colorant used.

Examples of the high-boiling point organic solvents favorable in the invention include the compounds represented by the following formulae [S-1] to [S-9].

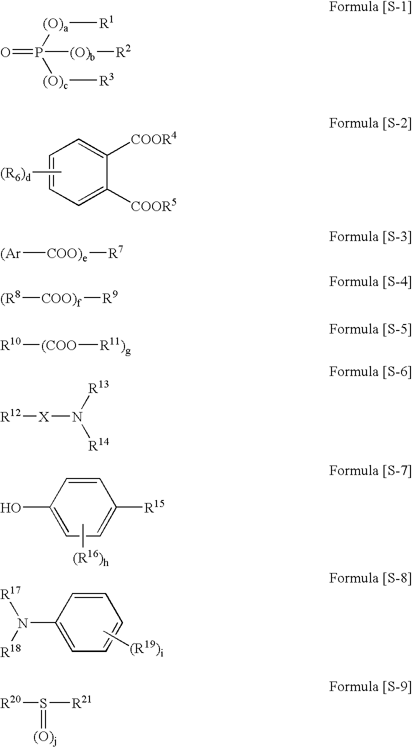

In the formula [S-1] above, R¹, R² and R³ each independently represent an aliphatic or aryl group; and each of a, b, and c is independently 0 or 1.

In the formula [S-2], R⁴ and R⁵ each independently represent an aliphatic or aryl group; R⁶ represents a halogen atom (F, Cl, Br, or I, hereinafter, the same shall apply), or an alkyl, alkoxy, aryloxy, alkoxycarbonyl or aryloxycarbonyl group; and d is an integer of 0 to 3. When d is 2 or more, the multiple R⁶ groups may be the same as or different from each other.

In the formula [S-3], Ar represents an aryl group; e is an integer of 1 to 6; and R⁷ represents an e-valent hydrocarbon group or an e-valent group wherein hydrocarbon groups are linked to each other via ether bonds.

In the formula [S-4], R⁸ represents an aliphatic group; f is an integer of 1 to 6; and R⁹ represents an f-valent hydrocarbon group or an f-valent group wherein hydrocarbon groups are linked to each other via ether bonds.

In the formula [S-5], g is an integer of 2 to 6; R¹⁰ represents a g-valent hydrocarbon group (excluding an aryl group); and R¹¹ represents an aliphatic or aryl group.

In the formula [S-6], R¹², R¹³ and R¹⁴ each independently represent a hydrogen atom, or an aliphatic or aryl group; X represents —CO— or —SO₂—; and R¹² and R¹³, or R¹³ and R¹⁴ may bind to each other, forming a ring.

In the formula [S-7], R¹⁵ represents an aliphatic, alkoxycarbonyl, aryloxycarbonyl, alkylsulfonyl, arylsulfonyl, aryl or cyano group; R¹⁶ represents a halogen atom or an aliphatic, aryl, alkoxy or aryloxy group; and h is an integer of 0 to 3. When h is 2 or more, the multiple R¹⁶ groups may be the same as or different from each other.

In the formula [S-8], R¹⁷ and R¹⁸ each independently represent an aliphatic or aryl group; R¹⁹ represents a halogen atom or an aliphatic, aryl, alkoxy or aryloxy group; and i is an integer of 0 to 4. When i is 2 or more, the multiple R¹⁹ groups may be the same as or different from each other.

In the formula [S-9], R²⁰ and R²¹ each independently represent an aliphatic or aryl group; j is 1 or 2; and R²⁰ and R²¹ may bind to each other, forming a ring.

In the formulae [S-1] to [S-9], when any of R¹ to R⁶, R⁸, and R¹¹ to R²¹ is an aliphatic group or a group containing an aliphatic group, the aliphatic group may be a straight-chain, branched-chain, or cyclic group, and may contain an unsaturated bond or an additional substituent group. Examples of the substituent groups include halogen atoms, aryl, alkoxy, aryloxy, alkoxycarbonyl, hydroxyl, acyloxy, and epoxy groups, and the like.

In the formulae [S-1] to [S-9], when any of R¹ to R⁶, R⁸, and R¹¹ to R²¹ is a cyclic aliphatic group, i.e., a cycloalkyl group or a group containing a cycloalkyl group, the cycloalkyl group may contain an unsaturated bond in its three- to eight-membered ring, and may have an additional substituent group or a crosslinking group. Examples of the substituent groups include halogen atoms and aliphatic, hydroxyl, acyl, aryl, alkoxy, epoxy, and alkyl groups, and the like; and examples of the crosslinking groups include methylene, ethylene, isopropylidene, and the like.

When any of R¹ to R⁶, R¹¹ to R²¹, and Ar in the formulae [S-1] to [S-9] is an aryl group or a group containing an aryl group, the aryl group may be substituted with a substituent group such as a halogen atom, an aliphatic, aryl, alkoxy, aryloxy, alkoxycarbonyl group, or the like.

When any of R⁷, R⁹ and R¹⁰ in the formulae [S-3], [S-4], and [S-5] is a hydrocarbon group, the hydrocarbon group may have a cyclic structure (e.g., benzene ring, cyclopentane ring, or cyclohexane ring) or an unsaturated bond, and may also be substituted. Examples of the substituent groups include halogen atoms, hydroxyl, acyloxy, aryl, alkoxy, aryloxy, and epoxy groups.

Hereinafter, particularly favorable high-boiling point organic solvents among the high-boiling point organic solvents represented by the formulae [S-1] to [S-9] will be described.

Preferably, in the formula [S-1], R¹, R² and R³ each independently represent an aliphatic group having 1 to 24 carbon atoms (preferably 4 to 18)(e.g., n-butyl, n-hexyl, n-octyl, EH-octyl, 2-ethylhexyl, 3,3,5-trimethylhexyl, 3,5,5-trimethylhexyl, n-dodecyl, n-octadecyl, benzyl, oleyl, 2-chloroethyl, 2,3-dichloropropyl, 2-butoxyethyl, 2-phenoxyethyl, cyclopentyl, cyclohexyl, 4-t-butylcyclohexyl, or 4-methylcyclohexyl), or an aryl group having 6 to 24 carbon atoms (preferably 6 to 18) (e.g., phenyl, cresyl, p-nonylphenyl, xylyl, cumenyl, p-methoxyphenyl, or p-methoxycarbonylphenyl). Among them, each of R¹, R² and R³ is preferably n-hexyl, n-octyl, EH-octyl, 2-ethylhexyl, 3,5,5-trimethylhexyl, n-dodecyl, 2-chloroethyl, 2-butoxyethyl, cyclohexyl, phenyl, cresyl, p-nonylphenyl, or cumenyl. Each of a, b, and c is independently 0 or 1, and more preferably, all of a, b, and c are 1.

Preferably, in the formula [S-2], R⁴ and R⁵ each independently represent an aliphatic group having 1 to 24 carbon atoms (preferably 4 to 18) (e.g., an aliphatic group exemplified above as R¹, heptyl, ethoxycarbonylmethyl, 1,1-diethylpropyl, 2-ethyl-1-methylhexyl, cyclohexylmethyl, 1-ethyl-1,5-dimethylhexyl, 3,5,5-trimethylcyclohexyl, menthyl, bornyl, or 1-methylcyclohexyl), or an aryl group having 6 to 24 carbon atoms (preferably 6 to 18) (e.g., an aryl group exemplified above as R¹, 4-t-butylphenyl, 4-t-octylphenyl, 1,3,5-trimethylphenyl, 2,4-di-t-butylphenyl, or 2,4-di-t-pentylphenyl). Among them, each of R⁴ and R⁵ is more preferably an aliphatic group, in particular an n-butyl, heptyl, 2-ethylhexyl, n-dodecyl, 2-butoxyethyl, or ethoxycarbonylmethyl group.

R⁶ is preferably an halogen atom (preferably chlorine atom), an alkyl group having 1 to 18 carbon atoms (e.g., methyl, isopropyl, t-butyl, or n-dodecyl), an alkoxy group having 1 to 18 carbon atoms (e.g., methoxy, n-butoxy, n-octyloxy, methoxyethoxy, or benzyloxy), an aryloxy group having 6 to 18 carbon atoms (e.g., phenoxy, p-tolyloxy, 4-methoxyphenoxy, or 4-t-butylphenoxy), an alkoxycarbonyl group having 2 to 19 carbon atoms (e.g., methoxycarbonyl, n-butoxycarbonyl, or 2-ethylhexyloxycarbonyl), or an aryloxycarbonyl group having 6 to 25 carbon atoms. Among them, R⁶ is more preferably an alkoxycarbonyl group and in particular a n-butoxycarbonyl group.

d is preferably 0 or 1.

In the formula [S-3], Ar is preferably an aryl group having 6 to 24 carbon atoms (preferably 6 to 18) (e.g., phenyl, 4-chlorophenyl, 2,4-dichlorophenyl, 4-methoxyphenyl, 1-naphthyl, 4-n-butoxyphenyl, 1,3,5-trimethylphenyl, or 2-(2-n-butoxycarbonylphenyl)phenyl); and among them, Ar is particular preferably a phenyl, 2,4-dichlorophenyl, or 2-(2-n-butoxycarbonylphenyl)phenyl group.

e is preferably an integer of 1 to 4 (more preferably 1 to 3).

R⁷ is preferably an e-valent hydrocarbon group having 2 to 24 carbon atoms (preferably 2 to 18) [e.g., an aliphatic group exemplified above as R⁴, n-octyl, an aryl group exemplified above as R⁴, —(CH₂)₂—, or 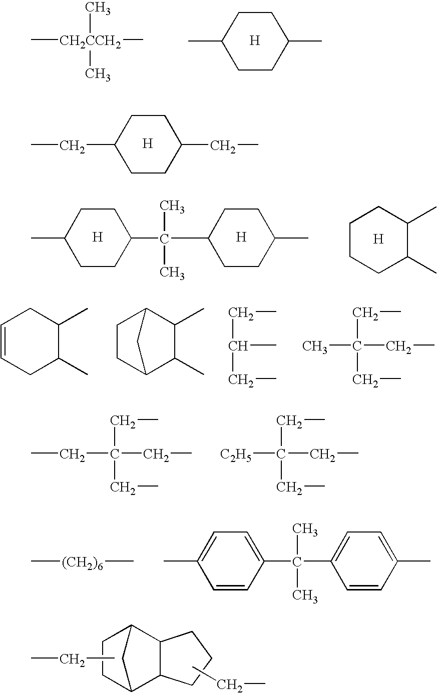
] or an e-valent group having 4 to 24 carbon atoms (preferably 4 to 18) wherein hydrocarbon groups are linked to each other via ether bonds [e.g., —CH₂CH₂OCH₂CH₂—, —CH₂CH₂(OCH₂CH₂)₃—, —CH₂CH₂CH₂OCH₂CH₂CH₂—, or the following linking groups].

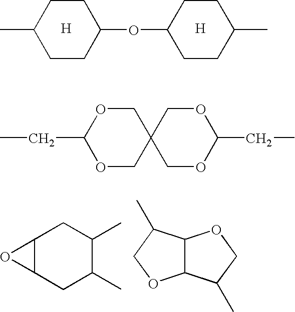

Among them, R⁷ is more preferably an alkyl group and in particular a n-butyl, n-octyl, or 2-ethylhexyl group.

In the formula [S-4], R⁸ is preferably an aliphatic group having 1 to 24 carbon atoms (preferably 1 to 17) (e.g., methyl, n-propyl, 1-hydroxyethyl, 1-ethylpentyl, n-heptyl, n-undecyl, n-tridecyl, pentadecyl, 8,9-epoxy heptadecyl, cyclopropyl, cyclohexyl, or 4-methylcyclohexyl); and among them, R⁸ is particularly preferably an n-heptyl, n-tridecyl, 1-hydroxyethyl, 1-ethylpentyl, or 8,9-epoxyheptadecyl group.

f is preferably an integer of 1 to 4 (more preferably 1 to 3).

R⁹ is preferably an f-valent hydrocarbon group having 2 to 24 carbon atoms (preferably 2 to 18) or an f-valent group having 4 to 24 carbon atoms (preferably 4 to 18) wherein hydrocarbon groups are linked to each other via ether bonds (e.g., a group exemplified above as R⁷, 1-methyl-2-methoxyethyl, or 2-hexyldecyl); and among them, R⁹ is particularly preferably a 2-ethylhexyl, 2-hexyldecyl, 1-methyl-2-methoxyethyl group, or the following linking groups.

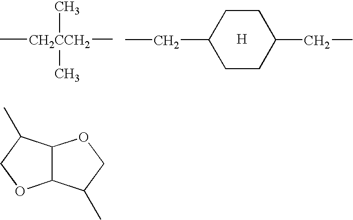

In the formula [S-5], g is preferably 2 to 4 (more preferably 2 or 3).

R¹⁰ is preferably a g-valent hydrocarbon group (e.g., —CH₂—, —(CH₂)₂—, —(CH₂)₄—, —(CH₂)₇—, —(CH₂)₈—, or the following linking groups 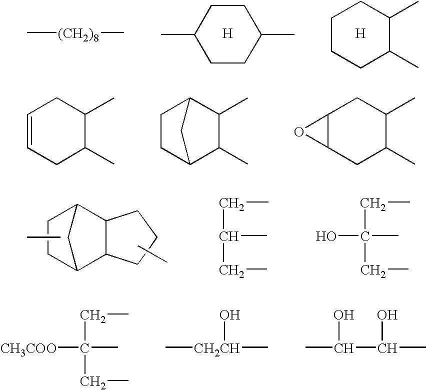
); and among them, R¹⁰ is particularly preferably —(CH₂)₄—, —(CH₂)₈—, or the following linking groups.

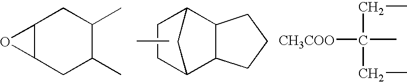

R¹¹ is preferably an aliphatic group having 1 to 24 carbon atoms (preferably 4 to 18) or an aryl group having 6 to 24 carbon atoms (preferably 6 to 18) (e.g., an aliphatic or aryl group exemplified above as R⁴); and among them, R¹¹ is more preferably an alkyl group and still more preferably an n-butyl, n-octyl, or 2-ethylhexyl group.

In the formula [S-6], R¹² is preferably a hydrogen atom, an aliphatic group having 1 to 24 carbon atoms (preferably 3 to 20) (e.g., n-propyl, 1-ethylpentyl, n-undecyl, n-pentadecyl, 2,4-di-t-pentylphenoxymethyl, 4-t-octylphenoxymethyl, 3-(2,4-di-t-butylphenoxy)propyl, 1-(2,4-di-t-butylphenoxy)propyl, cyclohexyl, 4-methylcyclohexyl, 8-N,N-diethylcarbamoyloctyl), or an aryl group having 6 to 24 carbon atoms (preferably 6 to 18) (e.g., an aryl group exemplified above as Ar, 3-methylphenyl, or 2-(N,N-di-n-octylcarbamoyl)phenyl); and among them, R¹² is particularly preferably an n-undecyl, 8-N,N-diethylcarbamoyloctyl, 3-methylphenyl, or 2-(N,N-di-n-octylcarbamoyl)phenyl group.

Each of R¹³ and R¹⁴ is preferably a hydrogen atom, an aliphatic group having 1 to 24 carbon atoms (preferably 1 to 18) (e.g., methyl, ethyl, isopropyl, n-butyl, n-hexyl, n-octyl, 2-ethylhexyl, n-dodecyl, n-tetradecyl, cyclopentyl, or cyclopropyl), or an aryl group having 6 to 18 carbon atoms (preferably 6 to 15) (e.g., phenyl, 1-naphthyl, p-tolyl); and among them, each of R¹³ and R¹⁴ is particularly preferably a methyl, ethyl, n-butyl, n-octyl, n-tetradecyl, or phenyl group.

R¹³ and R¹⁴ may bind to each other, forming an N-containing ring such as pyrrolidine, piperidine, or morpholine ring, and R¹² and R¹³ may bind to each other, forming an N-containing ring such as pyrrolidone or piperidine ring.

X is —CO— or —SO₂—, and preferably, X is —CO—.

In the formula [S-7], R₁₅ is preferably an aliphatic group having 1 to 24 carbon atoms (preferably 3 to 18) (e.g., methyl, isopropyl, t-butyl, t-pentyl, t-hexyl, t-octyl, 2-butyl, 2-hexyl, 2-octyl, 2-dodecyl, 2-hexadecyl, t-pentadecyl, cyclopentyl, or cyclohexyl), an alkoxycarbonyl group having 2 to 24 carbon atoms (preferably 5 to 17) (e.g., n-butoxycarbonyl, 2-ethylhexyloxycarbonyl, or n-dodecyloxycarbonyl), an aryloxycarbonyl group having 7 to 24 carbon atoms (preferably 7 to 18) (e.g., phenoxycarbonyl, naphthoxycarbonyl, or cresyloxycarbonyl), an alkylsulfonyl group having 1 to 24 carbon atoms (preferably 1 to 18) (e.g., methylsulfonyl, n-butylsulfonyl, or n-dodecylsulfonyl), an arylsulfonyl group having 6 to 30 carbon atoms (preferably 6 to 24) (e.g., p-tolylsulfonyl, p-dodecylphenylsulfonyl, or p-hexadecyloxyphenylsulfonyl), an aryl group having 6 to 32 carbon atoms (preferably 6 to 24) (e.g., phenyl, p-tolyl), a cycloalkyl group having 3 to 18 carbon atoms (more preferably 5 to 17) (e.g., cyclopentyl, or cyclohexyl), an aryl group having 6 to 32 carbon atoms (preferably 6 to 24) (e.g., phenyl, or p-tolyl), an alkoxy group having 1 to 24 carbon atoms (preferably, 1 to 18) (e.g., methoxy, n-butoxy, 2-ethylhexyloxy, benzyloxy, n-dodecyloxy, or n-hexadecyloxy), an aryloxy group having 6 to 32 carbon atoms (preferably 6 to 24) (e.g., phenoxy, p-t-butylphenoxy, p-t-octylphenoxy, m-pentadecylphenoxy, or p-dodecyloxyphenoxy) or a cyano group; and among them, R₁₅ is more preferably an aliphatic group and particularly preferably t-butyl, hexyl, octyl, or nonyl group.

In the formula [S-8], favorable examples of R¹⁷ and R¹⁸ are the same as those for R¹³ and R¹⁴ above excluding a hydrogen atom, and among them, each of R¹⁷ and R¹⁸ is more preferably an aliphatic group and particularly preferably an n-butyl, n-octyl, or n-dodecyl group. However, R¹⁷ and R¹⁸ do not bind to each other for forming a ring.

Favorable examples of R¹⁹ are the same as those for R¹⁶ above, and among them, R¹⁹ is more preferably an alkyl or alkoxy group and particularly preferably an n-octyl, methoxy, n-butoxy, or n-octyloxy group.

i is preferably an integer of 1 to 3.

In the formula [S-9], favorable examples of R²⁰ and R²¹ are the same as those for R¹, R² and R³ above when they do not bind to each other for forming a ring, and among them, each of R²⁰ and R²¹ is particularly preferably methyl, ethyl, butyl, hexyl, or octyl group.

R²⁰ and R²¹ may bind to each other, forming a ring, and the ring formed is preferably a five- or six-membered ring.

j is 1 or 2, and preferably j is 1.

Hereinafter, specific examples of the high-boiling point organic solvents for use in the invention [S-1 to 53] will be listed.

| Viscosity(mPa · s) | | |
|---|---|---|
| (25° C.) | (60° C.) | Boiling Point(° C.) |

Compounds represented by Formula[S-1]

| | | | | |
|---|---|---|---|---|
| S-1 | 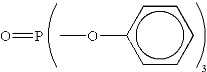 | — | 8.3 | 370 |
| S-2 | 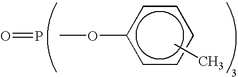 | 57.6 | 11.8 | 435 |
| S-3 | 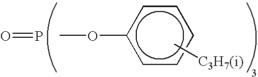 | 95 | 17.5 | 485 |
| S-4 | 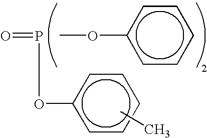 | 65 | 12.8 | 435 |
| S-5 | 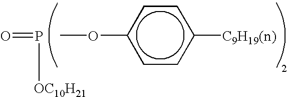 | 49 | 10.3 | 435 |
| S-6 | 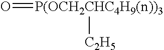 | 11.7 | 4.0 | 390 |
| S-7 | 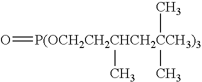 | 20.22 | 5.8 | 420 |
| S-8 | O═P(OC₁₂H₂₅(n))₃ | 28.6 | 6.9 | 480 |
| S-9 | O═P(OC₆H₁₃(n))₃ | 6.62 | 3.0 | 365 |
| S-10 | O═P(OCH₂CH₂Cl)₃ | 20.8 | 5.5 | 360 |
| S-11 | O═P(OCH₂CH₂OC₄H₉(n))₃ | 10.9 | 3.8 | 400 |
| S-12 | ((EH)C₈H₁₇)₃P═O | 41.1 | 9.0 | — |
| S-13 | 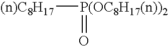 | 13.7 | 4.3 | — |

Compounds represented by Formula[S-2]

| | | | | |
|---|---|---|---|---|
| S-14 | 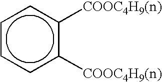 | 20.3 | 5.1 | 370 |
| S-15 | 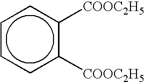 | 10.1 | 3.7 | 296 |
| S-16 | 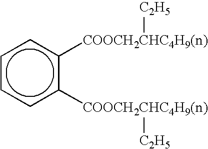 | 62.7 | 11.7 | 400 |
| S-17 | 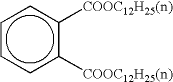 | 52.1 | 10.8 | — |
| S-18 | 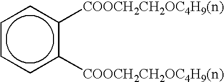 | 42 | 9.1 | 335 |
| S-19 | 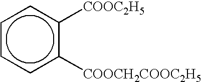 | 74 | 14.2 | 355 |
| S-20 | 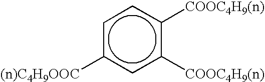 | 55.7 | 13.1 | 400 |

Compounds represented by Formula[S-3]

| | | | | |
|---|---|---|---|---|
| 5-21 | 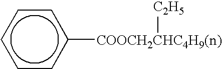 | 5.68 | 2.4 | 300 |
| S-22 | 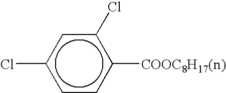 | 11.44 | 3.9 | 360 |
| S-23 | 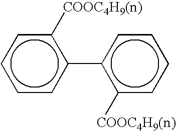 | 51.1 | 10.6 | — |

Compounds represented by Formula[S-4]

| | | | | |
|---|---|---|---|---|
| S-24 | 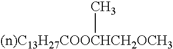 | 7.17 | 3.1 | 380 |
| S-25 | 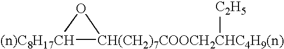 | 39.84 | 8.8 | — |
| S-26 | 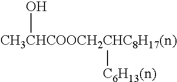 | 22.83 | 5.9 | — |
| S-27 | 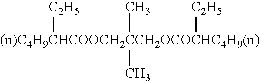 | 12 | 4.0 | — |
| S-28 | 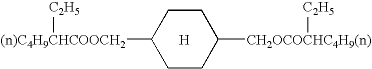 | 41.4 | 9.0 | 430 |
| S-29 | 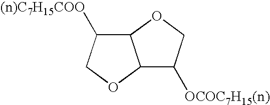 | 47.3 | 10.0 | 440 |

Compounds represented by Formula[S-5]

| | | | | |
|---|---|---|---|---|
| S-30 | 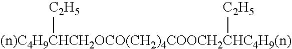 | 11.7 | 4.3 | 390 |
| S-31 | 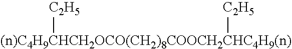 | 19.9 | 6.1 | 410 |
| S-32 | (n)C₄H₉OCO(CH₂)₈COOC₄H₉(n) | 8.09 | 3.5 | 345 |
| S-33 | 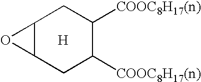 | 88.9 | 16.5 | — |
| S-34 | 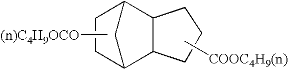 | 37.50 | 8.4 | 440 |
| S-35 | 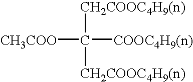 | 42.7 | 9.3 | 390 |

Compounds represented by Formula[S-6]

| | | | | |
|---|---|---|---|---|
| S-36 | 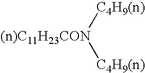 | 9.45 | 3.6 | 340 |
| S-37 | 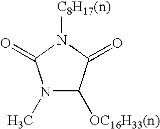 | 45.8 | 9.8 | — |
| S-38 | 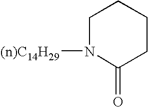 | 20.0 | 5.4 | 350 |
| S-39 | 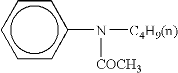 | 12.83 | 4.2 | 320 |
| S-40 | 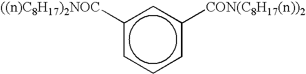 | 77.1 | 14.7 | — |
| S-41 | (C₂H₅)₂—NCO—(CH₂)₈—CON(C₂H₅)₂ | 40.7 | 8.9 | 405 |
| S-42 | 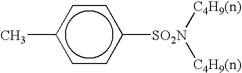 | 49.65 | 10.4 | — |

Compounds represented by Formula[S-7]

| | | | | |
|---|---|---|---|---|
| S-43 | 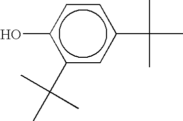 | 92 | 16.9 | — |

Compounds represented by Formula[S-8]

| | | | | |
|---|---|---|---|---|
| S-44 | 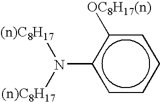 | 15.5 | 4.6 | — |
| S-45 | 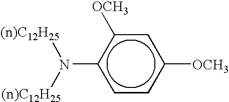 | 27.1 | 6.6 | — |
| S-46 | 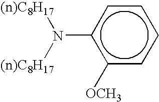 | 35.3 | 8.0 | — |
| S-47 | 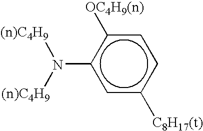 | 79.14 | 15.0 | — |

Compounds represented by Formula[S-9]

| | | | | |
|---|---|---|---|---|
| S-48 | 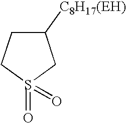 | 37.62 | 8.4 | — |
| S-49 | 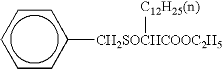 | 43.1 | 9.3 | — |

Other Compounds

| | | | | |
|---|---|---|---|---|
| S-50 | CₙH₂ₙ₊₁ (Mixture of normal-paraffin (n = 14, 15)) | 2.47 | 0.4 | 260 |
| | (for example, NP-SH manufactured | | | |
| | by Mitsui Texaco Chemical Co.) | | | |
| S-51 | 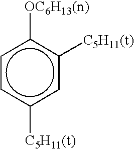 | 35.85 | 8.1 | 330 |
| S-52 | 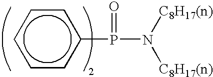 | 45.9 | 9.8 | — |
| S-53 | 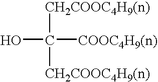 | 25.82 | 6.7 | — |

In the invention, the high-boiling point organic solvents may be used alone or in combination of two or more [e.g., combination of tricresyl phosphate and dibutyl phthalate, trioctyl phosphate and di(2-ethylhexyl)sebacate, or dibutyl phthalate and poly(N-t-butylacrylamide)].

In the ink set of the invention, the mass ratio of the colorant to the high-boiling point organic solvent, colorant: high-boiling point organic solvent, is preferably 1:0.01 to 1:1 and more preferably 1:0.05 to 1:0.5.

Other examples of the high-boiling point organic solvents for use in the invention in addition to those above and/or the preparative methods for the high-boiling point organic solvents are described, for example, in U.S. Pat. Nos. 2,322,027, 2,533,514, 2,772,163, 2,835,579, 3,594,171, 3,676,137, 3,689,271, 3,700,454, 3,748,141, 3,764,336, 3,765,897, 3,912,515, 3,936,303, 4,004,928, 4,080,209, 4,127,413, 4,193,802, 4,207,393, 4,220,711, 4,239,851, 4,278,757, 4,353,979, 4,363,873, 4,430,421, 4,430,422, 4,464,464, 4,483,918, 4,540,657, 4,684,606, 4,728,599, 4,745,049, 4,935,321, and 5,013,639; European Patent Nos. 276,319A, 286,253A, 289,820A, 309,158A, 309,159A, 309,160A, 509,311A, and 510,576A; East German Patent Nos. 147,009, 157,147, 159,573, and 225,240A; British Patent 2,091,124A; JP-A Nos. 48-47335, 50-26530, 51-25133, 51-26036, 51-27921, 51-27922, 51-149028, 52-46816, 53-1520, 53-1521, 53-15127, 53-146622, 54-91325, 54-106228, 54-118246, 55-59464, 56-64333, 56-81836, 59-204041, 61-84641, 62-118345, 62-247364, 63-167357, 63-214744, 63-301941, 64-9452, 64-9454, 64-68745, 1-101543, 1-102454, 2-792, 2-4239, 2-43541, 4-29237, 4-30165, 4-232946, and 4-346338; and others.

(Storage Stabilizer)

In the invention, a storage stabilizer may be added to the multiple liquids, for suppression of undesirable polymerization of the liquids during storage. The storage stabilizer is preferably used in a liquid containing a polymerizable compound, and is preferably soluble in the liquid or other components in the liquid.

Examples of the storage stabilizers include quaternary ammonium salts, hydroxyamines, cyclic amides, nitrites, substituted ureas, heterocyclic compounds, organic acids, hydroquinone, hydroquinone monoethers, organic phosphines, copper compounds, and the like; and specific examples thereof include benzyltrimethylammonium chloride, diethylhydroxylamine, benzothiazole, 4-amino-2,2,6,6-tetramethylpiperidine, citric acid, hydroquinone monomethylether, hydroquinone monobutylether, copper naphthenate, and the like.

The amount of the storage stabilizer added is preferably, properly adjusted according to the activity of the polymerization initiator used, the reactivity of the polymerizable compound, and the kind of the storage stabilizer used, but is preferably 0.005 to 1 mass %, more preferably 0.01 to 0.5 mass %, and still more preferably 0.01 to 0.2 mass %, as solid matter in the liquid, from the viewpoints of the balance of storage stability and ink-curability when the liquids are mixed.

(Conductive Salts)

Conductive salts are solid compounds which dissolve in a liquid to heighten the conductivity of the liquid. In the invention, it is preferable to use substantially no conductive salts since the conductive salts are likely to precipitate during storage. However, an adequate amount of a conductive salt may be used if the solubility of the conductive salt in the liquid is high for the reason that the conductive salt or liquid component in the liquid has a high solubility. The conductive salt may be potassium thiocyanate, lithium nitrate, ammonium thiocyanate, or dimethylamine hydrochloride.

(Solvent)

A solvent may be added for improvement of ink polarity, viscosity, surface tension, and solubility/dispersibility of colorant, and for control of conductivity and printing performance. The solvent may be a water-insoluble liquid.

The “water-insoluble liquid” means a liquid having a water solubility (25° C.), as described above, of 4 g or less, preferably 3 g or less, more preferably 2 g or less, and particularly preferably 1 g or less.

Use of a water-insoluble liquid containing no aqueous solvent as the solvent is favorable from the viewpoints of ink ejection stability and drying speed, and in particular, use of the high-boiling point organic solvent described above is preferable.

The low-boiling point organic solvent is an organic solvent having a boiling point of 100° C. or lower. Use of a low-boiling point organic solvent is preferably avoided, because the solvent may affect the curability and lead to environmental pollution. If used, it is preferably a safer solvent, and the safer solvent is a solvent having a higher standard control concentration (an indicator used in evaluation of working environment), and solvents having a control concentration of 100 ppm or more are preferable, and those having a control concentration of 200 ppm or more are more preferable. Examples thereof include alcohols, ketones, esters, ethers, hydrocarbons, and the like; and specific examples thereof include methanol, 2-butanol, acetone, methylethylketone, ethyl acetate, tetrahydrofuran, and the like.

The solvents may be used alone or in combination of two or more; when water and/or a low-boiling point organic solvent are used, the amount of them in each liquid is preferably 0 to 20 mass %, more preferably 0 to 10 mass %, and particularly preferably, practically zero. The phrase “the amount is practically zero” means that presence of unavoidable impurities is allowed. Presence of water in the liquid is undesirable, from the viewpoint of stability over time, i.e., increase in turbidity due to disproportionation of the liquid over time, precipitation of dye and others, and also from the viewpoint of the drying characteristics when a non-water-adsorbing recording medium is used.

(Other Additives)

In addition, other known additives, such as solvent, polymer, surface-tension adjuster, ultraviolet absorbent, antioxidant, discoloration inhibitor, and pH adjuster, may also be used in combination.

Any known compounds may be properly selected and used as the surface-tension adjuster, ultraviolet absorbent, antioxidant, discoloration inhibitor, or pH adjuster, and specific examples thereof are described, for example, in JP-A No. 2001-181549.

In addition to the additives above, a pair of compounds that react by mixing to generate aggregates or increase the viscosity of the liquid may be added to different liquids, respectively. The pair of compounds form aggregates rapidly or increase the viscosity of the liquid rapidly, thus preventing interference between neighboring droplets (line width broadening) and tackiness, and improving abrasion resistance, more effectively.

Examples of the reactions of the pair of compounds that react by mixing to generate aggregates or increase the viscosity of liquid include acid/base reactions, hydrogen-bonding reactions of a carboxylic acid/an amide group-containing compound, crosslinking reactions such as a reaction of boronic acid and a diol, reactions by electrostatic interaction between a cation and an anion, and the like.

<<Inkjet Image-Recording Method>>

Hereinafter, the inkjet image-recording method according to the invention will be described.

The inkjet image-recording method according to the invention forms an image on a recording medium by using the multiple liquids including the first and second liquids described above and applying the first and second liquids simultaneously or sequentially in either order onto the recording medium.

By applying the first liquid containing no colorant but containing the hydrophobic polymer according to the invention and the second liquid containing no hydrophobic polymer according to the invention but containing a colorant, it is possible to effectively prevent bleeding and line width broadening and give an image having suppressed tackiness and superior abrasion resistance without color separation.

In the description above, the second liquid containing a colorant is preferably applied onto a recording medium by ejection by an inkjet nozzle, and the second liquid is preferably ejected by an inkjet nozzle simultaneously with or after application of the first liquid, for prevention of bleeding, line width broadening and tackiness, and for improvement of abrasion resistance.

(Process of Applying Liquids)

The process of applying the first liquid onto a recording medium in the image-recording method will be described below. With respect to the process of applying the second liquid, ejection by inkjet nozzles (which is a preferable embodiment) as described above will be described as an example.

The application process is not particularly limited, and specific examples thereof include the following two processes.

(i) Coating Using a Coating Apparatus

In the inkjet image recording method according to the invention, an image is preferably formed by coating the first liquid on a recording medium using a coating apparatus and ejecting the second liquid thereon by an inkjet nozzle.

The coating apparatus is not particularly limited, and any of known coating apparatuses may be selected according to application, and examples thereof include an IP doctor coater, blade coater, rod coater, knife coater, squeeze coater, impregnation coater, reverse roll coater, transfer roll coater, gravure coater, kiss roll coater, cast coater, spray coater, curtain coater, extrusion coater, and the like. Other coating methods are also described in Yuji Harasaki, “Coating Engineering”.

The inkjet nozzle is also not particularly limited, and any of known nozzles may be selected according to application.

The system of ejecting liquids by inkjet nozzles (inkjet-recording system) will be described below. Any of known systems such as an electric charge-control system of ejecting ink by using electrostatic attraction, drop-on-demand system (pressure pulse system) of using the vibrational pressure by a piezoelectric element, acoustic inkjet system of ejecting ink by using the acoustic radiation pressure generated by irradiation of acoustic beam converted from electrical signal on the ink, and thermal inkjet (bubble jet™) system of using the pressure generated by heating the ink and forming air bubble may be used favorably in the invention.

The inkjet-recording systems include a system of ejecting a lot of small volume droplets of a so-called photo ink having a low concentration, a system of using multiple inks that have substantially the same hue and a different concentration for improving image quality, and a system of using a transparent and colorless ink.

The liquids other than the first and second liquids may be applied onto the recording medium by any process, for example, by coating using the coating apparatus or ejection by an inkjet nozzle, and the timing of application is also not particularly limited, but, if the liquid contains a colorant, the liquid is preferably ejected by an inkjet nozzle after the first liquid has been applied.

(ii) Ejection by an Inkjet Nozzle

An image is preferably formed by ejecting the first liquid by an inkjet nozzle and ejecting the second liquid by an inkjet nozzle simultaneously with or after the ejection of the first liquid.

The inkjet nozzle is the same as that described above.

Similarly to above, the liquids other than the first and second liquids may be applied onto the recording medium by any process, for example by coating using the coating apparatus or ejection by an inkjet nozzle, and the timing of application is also not particularly limited, but, if the liquid contains a colorant, the liquid is preferably ejected by an inkjet nozzle after the first liquid has been applied.

The inkjet-recording ink set according to the invention described below shows its advantageous effects more effectively, when used in the inkjet image-recording method wherein all other liquids are ejected by inkjet nozzles according to the process (ii).

In the case of the process (i), an image is formed by ejecting at least the second liquid by the inkjet-recording system on a recording medium on which the first liquid has been coated. Alternatively in the case of the process (ii), an image is formed by ejecting at least the first and second liquids on a recording medium simultaneously or sequentially in either order by the inkjet-recording system.

When two or more liquids are ejected onto a recording medium by the inkjet-recording system, these liquids are applied so as to be in contact with each other. The state of contact between the two or more liquids is not particularly limited, and the liquids may be ejected adjacently to each other or be ejected to overlap in the same area.

The timing of ejection is arbitrary and may be either simultaneous or sequential, but when the liquids are ejected sequentially, within 1 second after one of the liquids is ejected first, the next liquid is preferably ejected. The amount of the droplet is also not particularly limited, and is selected properly according to the intended sharpness of the image formed, but generally, the amount of the liquid per droplet is preferably, approximately 0.5 to 10 pl.

In the invention, the ratio of the amounts of respective liquids to be applied for one dot is, in the case of the two-liquid type ink set, preferably such that the ratio of the application amount of the first liquid to the application amount of the second liquid is in the range of 0.5:5 to 5:0.5 from the viewpoints of the reactivity and the viscosity.

Physical properties favorable for all the liquids (inks) including the first and second liquids to be ejected onto a recording medium by the inkjet-recording system may vary according to the printing apparatus used, but generally, the viscosity at 25° C. of each liquid is preferably 5 to 100 m Pa·s and more preferably 10 to 80 m Pa·s. The surface tension of each liquid is preferably 20 to 60 mN/m and more preferably 30 to 50 mN/m.

In addition, the difference in viscosity at 25° C. between the first and second liquids is preferably 25 m Pa·s or less, and the difference in surface tension between the first and second liquids is preferably 20 mN/m or less.

(Energy-Applying Step)

The image-recording method may also have a step of fixing the image after image formation by applying activation energy for improving fixability. By application of activation energy, it is possible to accelerate polymerization and curing reaction in aggregate and form a stronger image more efficiently. The application of activation energy is preferably performed by photoirradiation or heating.

Formation of active species by decomposition of the polymerization initiator in the mixed liquid is accelerated by application of energy such as exposure to light or heating, and the increase in the amount of active species and in temperature accelerate polymerization and curing reaction of the polymerizable compound by the active species.

Ultraviolet or visible light may be used as the irradiation source for polymerization of the polymerizable compound in the invention. It is also possible to apply energy by irradiating a radiation ray other than light such as α-ray, γ-ray, X-ray, or electron beam, but among them, use of ultraviolet or visible light is preferable, and use of ultraviolet light is more preferable, from the points of cost and safety. The amount of energy needed for the curing reaction may vary according to the kind and content of the polymerization initiator, but is generally, approximately 1 to 500 mJ/cm².

During application of energy by heating, the recording medium surface is preferably heated under the condition of a temperature in the range of 40 to 80° C. for 0.1 to 1 second.

The recording medium may be heated by non-contact heating method, preferably, for example, by feeding the medium through a heating furnace such as oven, irradiating the entire-surface with UV, visible or infrared light, or the like. Examples of the light sources used for exposure as heating method include metal halide lamp, xenon lamp, tungsten lamp, carbon arc lamp, mercury lamp, and the like.

(Recording Medium)

Both an ink-penetrable recording medium and a non-ink-penetrable recording medium can be used in the invention. Examples of the ink-penetrable recording media include plain paper, inkjet-exclusive paper, coated paper, electrophotographic common-use paper, cloth, nonwoven fabric, porous film, polymer absorbent, and the like. These recording media are described as the “recording materials” in JP-A No. 2001-1891549 and others.

The advantageous effects of the invention are observed more distinctively on a non-ink-penetrable recording medium. Examples of the non-ink-penetrable recording media include art paper, synthetic resin, rubber, resin-coated paper, glass, metal, ceramics, wood, and the like. In addition, a composite material in combination of these materials may also be used for expression of other functions.

Any synthetic resins may be used as the synthetic resin, and examples thereof include polyesters such as polyethylene terephthalate and polybutadiene terephthalate, polyvinyl chloride, polystyrene, polyurethane, polyolefins such as polyethylene and polypropylene, acrylic resins, polycarbonate, acrylonitrile-butadiene-styrene copolymers, diacetate, triacetate, polyimide, cellophane, celluloid, and the like; and the thickness and shape of these synthetic resin base materials are not particularly limited, and the base material may be in the shape of film, card, or block. The synthetic resin may be transparent or opaque.

The synthetic resin is preferably used as in the shape of so-called soft packaging film, and various non-absorptive plastics and the films thereof may be used, and examples of the various plastic films include PET film, OPS film, OPP film, PNy film, PVC film, PE film, TAC film, and the like. Other plastics such as polycarbonate, acrylic resins, ABS, polyacetal, PVA, and rubbers may also be used.

Examples of the resin-coated papers include transparent polyester film, opaque polyester film, opaque polyolefin resin film, paper supports laminated with a polyolefin resin on both faces, and the like; and particularly preferable are the paper supports laminated with a polyolefin resin on both faces.

Hereinafter, a paper support laminated with polyethylene which is an example of the most preferable polyolefin will be described.

The base paper for use as a paper support is prepared by sheeting a primary raw material of wood pulp, and additionally a synthetic pulp such as polypropylene or a synthetic fiber such as of nylon or polyester as needed. The wood pulp may be any of LBKP, LBSP, NBKP, NBSP, LDP, NDP, LUKP, and NUKP; but preferably LBKP, NBSP, LBSP, NDP, and LDP, which contain a greater amount of short fibers, are mainly used. However, the ratio of LBSP and/or LDP is preferably 10 mass % or more but 70 mass % or less.

Chemical pulps (sulfate salt pulp and sulfite pulp) containing a smaller amount of impurities are favorably used, and bleached pulps higher in whiteness are also useful.

Various additives including higher fatty acid, sizing agent such as alkylketene dimer, white pigment such as calcium carbonate, talc or titanium oxide, paper-strength additive such as starch, polyacrylamide, or polyvinyl alcohol, fluorescent whitening agent, moisturizing agent such as polyethylene glycols, dispersant, softener such as quaternary ammonium, and the like may be added to the base paper as needed.

The freeness of the pulp for use in sheeting is preferably 200 to 500 ml as Canadian Standard Freeness (CSF), and in regard to the fiber length after beating, the pulps remaining on 24- and 42-mesh screens, as specified in JIS P8207, is preferably 30 to 70 mass %. Further, the pulp remaining on 4-mesh screen is preferably 20 mass % or less.

The basis weight of the base paper is preferably 30 to 250 g and more preferably 50 to 200 g. The thickness of the base paper is preferably 40 to 250 μm. The base paper may be calendered for improvement in surface smoothness during or after the sheeting step. The density of the base paper (as determined according to the method specified in JIS P8118) is generally 0.7 to 1.2 g/m².

In addition, the stiffness as specified in JIS P8143 (1998) of the base paper is preferably 20 to 200 g.

A surface-sizing agent may be applied onto the surface of the base paper, and any of sizing agents similar to those which may be added to the base paper can be used as the surface sizing agent.

The pH of the base paper is preferably 5 to 9, as determined by the hot-water extraction method specified in JIS P8113 (1998).

The polyethylene covering the both surfaces of the base paper is mainly a low-density polyethylene (LDPE) and/or a high-density polyethylene (HDPE), but other LLDPE, polypropylene, or the like may also be used partially.

The polyethylene layer at the coating layer side is preferably a layer that is improved in opacity and whiteness by adding a rutile or anatase titanium oxide into a polyethylene, as commonly conducted in photographic printing papers. The content of the titanium oxide is preferably about 1 to 20 mass %, more preferably 2 to 15 mass % with respect to the polyethylene.

The polyethylene-coated paper may be used as a glossy paper. Alternatively, the polyethylene layer coated on the surface of the base paper by melt-extrusion may be subjected to a surface modification treatment such as embossing so as to have a mat or silky surface similar to common photographic printing papers.

The amount of polyethylene used in both surfaces of the base paper is selected so that the thickness of the aqueous coating composition and the curl of the base paper having been provided with a back layer in low-humidity and high-humidity environments are optimized, but the thickness of the polyethylene layer at the surface where the aqueous coating composition according to the invention is coated is preferably in the range of 20 to 40 μm, and that at the back layer side is preferably in the range of 10 to 30 μm.

The metal is arbitrary, and favorable examples thereof include metals such as aluminum, iron, gold, silver, copper, nickel, titanium, chromium, molybdenum, silicon, lead, and zinc; and composite materials thereof such as stainless steel.

### EXAMPLES

Hereinafter, the invention will be described in detail with reference to Examples, but it should be understood that the present invention is not restricted thereby.

### Example 1

Inkjet-recording inks shown below were prepared and evaluated. Methods of preparing inks containing a pigment are shown below.

<Preparation of Pigment Cyan Ink Liquid (I-0) Containing Polymerizable Compounds>

(A) Polymerizable compound: DPCA60 (manufactured by Nippon Kayaku Co., Ltd.) 0.38 g
(B) Polymerizable compound: 1,6-hexanediol diacrylate 11.60 g (HDDA manufactured by Daicel UCB)
(C) N-Ethyldiethanolamine 0.20 g
(D) Colorant <pigment: copper phthalocyanine PB15:3> 1.40 g

The components above were mixed and dissolved while agitated, to give a pigment cyan ink liquid (I-0) (second liquid). The viscosity of the pigment cyan ink liquid (I-0) was 19.6 m Pa·s.

<Preparation of Inkjet-Recording Ink Liquid Containing a Hydrophobic Polymer (II-1)>

(E) High-boiling point organic solvent (exemplary compound (S-15)) 4.15 g
(F) Polymerization initiator (TPO-L (following initiator-1)) 0.6 g
(G) Hydrophobic polymer (exemplary compound A-5) 0.08 g

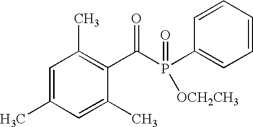

### Initiator-1

The components above were mixed and dissolved while agitated, to give a liquid (II-1) (first liquid).

<Preparation of Inkjet-Recording Ink Liquids (II-2) to (II-9) Containing a Polymer Compound>

Inkjet-recording ink liquids containing a hydrophobic polymer (II-2) to (II-9) (first liquid) were prepared in a similar manner to the liquid (II-1), except that the hydrophobic polymer used in preparation of the inkjet-recording ink liquid (II-1) was replaced with the polymer shown in the following Table 1 in the same amount.

The polymer compounds used in preparation of the liquids (I-1 ) to (II-9) and the liquid viscosity of the resulting liquids are summarized in the following Table 1.

TABLE 1

| | Hydrophobic polymer | | | | |
|---|---|---|---|---|---|
| | | Weight- | | | |
| | | average | | | |
| | | molecular | | | Ink viscosity |
| | | weight | Inorganicity | I/O ratio | (mPa · s) |
| II-1 | A-5 | 8000 | 0 | 0.27 | 16.2 |
| II-2 | A-1 | 6000 | 0 | 0.60 | 15.5 |
| II-3 | A-3 | 10000 | 0 | 0.33 | 16.3 |
| II-4 | A-8 | 5000 | 20 | 0.57 | 14.4 |
| II-5 | M-4 | 15000 | 0 | 0.25 | 16.6 |
| II-6 | M-5 | 12000 | 0 | 0.25 | 15.5 |
| II-7 | M-7 | 16000 | 0 | 0.17 | 17.1 |
| II-8 | M-9 | 6000 | 35 | 0.50 | 16.3 |
| II-9 | B-1 | 10000 | 0 | 0.28 | 15.0 |

*In the Table, the “inorganicity” is the inorganicity of the group corresponding to R² in the formula (I), and the “I/O ratio” is the I/O ratio of the hydrophobic polymer.

<Single-Liquid Inkjet-Recording Ink Liquid I-00 for Comparison>

The components below were mixed and dissolved while agitated, to give a comparative ink liquid I-00.
(A) Polymerizable compound: DPCA60 (manufactured by Nippon Kayaku Co., Ltd.) 0.38 g
(B) Polymerizable compound: 1,6-hexanediol diacrylate 11.60 g (HDDA manufactured by Daicel UCB)
(C) N-Ethyldiethanolamine 0.20 g
(D) Colorant <pigment: copper phthalocyanine PB15:3> 1.40 g
(E) High-boiling point organic solvent (exemplary compound (S-15)) 12.10 g
(F) Polymerization initiator (initiator-1 above) 1.81 g
   <Single-Liquid Inkjet-Recording Ink Liquid I-000 for Comparison>

The components below were mixed and stirred, to give a comparative ink liquid I-000.
(A) Styrene-maleic anhydride copolymer 0.22 g
(B) Polymerizable compound: DPCA60 (manufactured by Nippon Kayaku Co., Ltd.) 0.38 g
(C) Polymerizable compound: 1,6-hexanediol diacrylate 11.60 g (HDDA manufactured by Daicel UCB)
(D) N-Ethyldiethanolamine 0.20 g
(E) Colorant <pigment: copper phthalocyanine PB15:3> 1.40 g
(F) High-boiling point organic solvent (exemplary compound (S-1 5)) 10.10 g
(G) Polymerization initiator (the initiator-1) 1.81 g
   <Two-Liquid Inkjet-Recording Ink Liquid (II-0) for Comparison>

The components below were mixed and dissolved while stirred, to give a comparative ink liquid II-0.
(A) Ethyl acetate 10.0 g
(B) Polymerization initiator (TPO-L (initiator-1 above)) 1.8 g
(C) Styrene-maleic anhydride copolymer 2.0 g
   <Evaluation>

An image was printed with the pigment cyan ink liquid (I-0) prepared (hereinafter, referred to simply as “liquid I” in some cases) on a recording medium using an inkjet printer (manufactured by Microjet Ltd., test machine, printing density: 300 dpi, ejection frequency: 2 KHz, nozzle number: 64, two-row arrangement).

An image was also printed with each of the comparative ink liquids I-00 and I-000 in a similar manner to the pigment cyan ink liquid (I-0). However, the ejection frequency was 4 KHz. The comparative ink I-000 caused nozzle clogging, resulting in unstable ejection.

An image was printed with each of the ink liquids (II-1) to (II-9) and (II-0) (hereinafter, referred to simply as “liquids II”) in a similar manner to the pigment cyan ink liquid (I-0). In this case, after ejection of each of the ink liquids (II-1) to (II-9) and (II-0), the pigment cyan ink liquid (I-0) was ejected onto the same area of the recording medium where each of the ink liquids (II-1) to (II-9) and (II-0) was ejected.

The recording medium used was a polyethylene terephthalate (PET) sheet having a thickness of 60 μm (product name: Xerox film OHP FILM for PPL/laser printer, manufactured by Fuji Xerox Co., Ltd.) or an art paper (product name: Tokuhishi Art double-sided, manufactured by Mitsubishi Paper Mills Ltd.).

The image printed was UV-irradiated, 60 seconds after printing, at an ultraviolet ray amount of 500 mJ/cm² by using a metal halide lamp at a wavelength of 365 nm. Each image obtained was evaluated in the tests below. Results are summarized in Table 2.

<Evaluation of Interference Between Ejected Droplets >

(Line Width)

The liquids I and II were ejected respectively to overlap with each other in a line shape, and the appearance of the line shape when there was a period between printing and exposing (60 seconds) was evaluated according to the following criteria. However, only one liquid was ejected in a line shape when (I-00) or (I-000) was used.

A: The line width is uniform and 0.3 mm or less.

(0.3 mm represents a magnification factor of approximately 3. The magnification factor is a ratio of the line width to the diameter of the ink droplet just before contacting with the recording medium.)

B: The line width is uniform, but more than 0.3 mm.

C: There is distinct fluctuation in line width due to locally gathered liquid on the line.

<Evaluation of Line Color Separation>

The liquids I and II were ejected respectively to overlap with each other in a line shape, and the color separation of the line was evaluated according to the following criteria:

A: No color separation is observed.

B: Slight color separation is observed, and a slight missing part is observed in the center.

C: Distinct color separation is observed, and a thick missing part is observed in the center.

<Evaluation of Tackiness>

The printed surface was touched with fingers, and the tackiness is evaluated according to the following criteria.

A: Not tacky

B: Slightly tacky

C: Distinctly tacky

<Evaluation of Abrasion Resistance>

An image was formed on a PET sheet or art paper as described above. 30 minutes after the printing, the image was reciprocatingly rubbed 10 times with an eraser, and the change after the rubbing was evaluated according to the following criteria.

A: No decrease in density at all

B: Slight decrease in density

C: Distinct decrease in density

TABLE 2

| | | Line | | | | |
|---|---|---|---|---|---|---|
| | | | Color | | | |
| | Recording | | sepa- | Tack- | Abrasion | |
| Ink liquid | medium | Width | ration | iness | resistance | Remarks |
| I-0/II-1 | PET | A | A | A | A | Example |
| I-0/II-1 | Art paper | A | A | A | A | Example |
| I-0/II-2 | PET | A | A | A | A | Example |
| I-0/II-2 | Art paper | A | A | A | A | Example |
| I-0/II-3 | PET | A | A | A | A | Example |
| I-0/II-3 | Art paper | A | A | A | A | Example |
| I-0/II-4 | PET | A | A | A | A | Example |
| I-0/II-4 | Art paper | A | A | A | A | Example |
| I-0/II-5 | PET | A | A | A | A | Example |
| I-0/II-5 | Art paper | A | A | A | A | Example |
| I-0/II-6 | PET | A | A | A | A | Example |
| I-0/II-6 | Art paper | A | A | A | A | Example |
| I-0/II-7 | PET | A | A | A | A | Example |
| I-0/II-7 | Art paper | A | A | A | A | Example |
| I-0/II-8 | PET | A | A | A | A | Example |
| I-0/II-8 | Art paper | A | A | A | A | Example |
| I-0/II-9 | PET | A | A | A | A | Example |
| I-0/II-9 | Art paper | A | A | A | A | Example |
| I-0/II-0 | PET | C | A | A | A | Comparative |
| | | | | | | Example |
| I-0/II-0 | Art paper | C | A | A | A | Comparative |
| | | | | | | Example |
| I-00 | PET | C | A | A | A | Comparative |
| | | | | | | Example |
| I-00 | Art paper | C | A | A | A | Comparative |
| | | | | | | Example |
| I-000 | PET | C | A | A | A | Comparative |
| | | | | | | Example |
| I-000 | Art paper | C | A | A | A | Comparative |
| | | | | | | Example |

As apparent from Table 2, by applying separately the ink composition according to the invention containing a hydrophobic polymer according to the invention (the first liquid) and a pigment-containing liquid (second liquid) so as to overlap with each other, it is possible to prevent the change in the shape of the ink ejected on an non-ink-absorptive PET sheet or art paper even when there is a period between printing and exposing. Further in the invention, by using a metal halide lamp with a wavelength of 365 nm and irradiating ultraviolet ray at an intensity of approximately 500 mJ/cm², it is possible to promote the curing reaction efficiently and rapidly, and obtain an image having superior printability, less tackiness and high abrasion resistance.

The present invention provides at least the following embodiments 1 to 18.

1. An ink set comprising multiple liquids including at least first and second liquids, wherein the first liquid contains a hydrophobic polymer, and the hydrophobic polymer comprises at least a unit represented by the following formula (1):

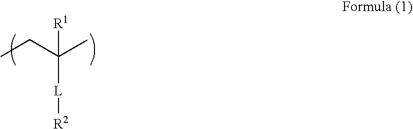

wherein R¹ represents a hydrogen atom or an alkyl group that may have a substituent group; R² represents an alkyl or aryl group that may have a substituent group; and L represents a linking group selected from the group consisting of —C(═O)O—, —O—, and —OC(═O)—.

2. The ink set of embodiment 1, wherein R² in the formula (1) is a group having an inorganicity according to the organic conceptual diagram of less than 70.

3. The ink set of embodiment 1, wherein the hydrophobic polymer has an inorganicity/organicity ratio (I/O ratio) according to the organic conceptual diagram of 1 or less.

4. The ink set of embodiment 1, wherein R¹ in the formula (1) is a hydrogen atom.

5. The ink set of embodiment 1, wherein the second liquid contains a polymerizable or crosslinkable material.

6. The ink set of embodiment 1, wherein the second liquid contains a colorant.

7. The ink set of embodiment 1, wherein the first liquid further contains a colorant in an amount that corresponds to a solution absorbance of 0 to 0.5 at the maximum absorption wavelength of the first liquid at a thickness of 1 cm.

8. The ink set of embodiment 1, wherein at least one of the first and second liquids contains a high-boiling point organic solvent that has (1) a viscosity of 100 mPa·s or less at 25° C. or 30 mPa·s or less at 60° C. and (2) a boiling point of higher than 100° C.

9. The ink set of embodiment 8, wherein the high-boiling point organic solvent is contained in the first liquid.

10. The ink set of embodiment 6, wherein the colorant is a pigment.

11. The ink set of embodiment 1, wherein one or more of the multiple liquids contain a water-insoluble liquid as a solvent.

12. An inkjet recording ink set comprising the ink set of embodiment 1.

13. An inkjet image-recording method using the ink set according to embodiment 1, comprising applying the first and second liquids simultaneously or sequentially in either order onto a recording medium to form an image.

14. The inkjet image-recording method of embodiment 13, wherein the image is formed by ejecting the second liquid onto the recording medium by an inkjet nozzle simultaneously with, or after application of, the first liquid onto the recording medium.

15. The inkjet image-recording method of embodiment 13, wherein the application of the first liquid onto the recording medium is carried out by coating using a coating apparatus, and the second liquid is ejected onto the recording medium by an inkjet nozzle after the coating of the first liquid onto the recording medium.

16. The inkjet image-recording method of embodiment 13, wherein the application of each of the first and second liquids onto the recording medium is carried out by inkjet nozzle ejection.

17. The inkjet image-recording method of embodiment 13, further comprising fixing the image formed on the recording medium by application of activation energy.

18. The inkjet image-recording method of embodiment 17, wherein the activation energy is applied by photoirradiation or heating.

Accordingly, the invention can provide an ink set that has long-term storage stability and superior fixability, prevents bleeding and changes in the ejected ink shape (line width broadening) that can occur when there is a period between printing and exposing, and gives high-quality images.

The invention can also provide an inkjet image-recording method that maintains superior fixability, while preventing bleeding and changes in the ejected ink shape (line width broadening) that can occur when there is a period between printing and exposing, and can form high-quality images having suppressed tackiness and superior abrasion resistance.

What is claimed is:

1. An ink set comprising multiple liquids including at least first and second liquids, wherein the first liquid contains a hydrophobic polymer, and the hydrophobic polymer comprises at least a unit represented by the following formula (1): 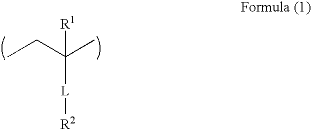
wherein R¹ represents a hydrogen atom or an alkyl group that may have a substituent group; R² represents an alkyl or aryl group that may have a substituent group; and L represents a linking group selected from the group consisting of —C(═O)O—, —O—, and —OC(═O)—.

2. The ink set of claim 1, wherein R² in the formula (1) is a group having an inorganicity according to the organic conceptual diagram of less than 70.

3. The ink set of claim 1, wherein the hydrophobic polymer has an inorganicity/organicity ratio (I/O ratio) according to the organic conceptual diagram of 1 or less.

4. The ink set of claim 1, wherein R¹ in the formula (1) is a hydrogen atom.

5. The ink set of claim 1, wherein the second liquid contains a polymerizable or crosslinkable material.

6. The ink set of claim 1, wherein the second liquid contains a colorant.

7. The ink set of claim 1, wherein the first liquid further contains a colorant in an amount that corresponds to a solution absorbance of 0 to 0.5 at the maximum absorption wavelength of the first liquid at a thickness of 1 cm.

8. The ink set of claim 1, wherein at least one of the first and second liquids contains a high-boiling point organic solvent that has (1) a viscosity of 100 mPa·s or less at 25° C. or 30 mPa·s or less at 60° C. and (2) a boiling point of higher than 100° C.

9. The ink set of claim 8, wherein the high-boiling point organic solvent is contained in the first liquid.

10. The ink set of claim 6, wherein the colorant is a pigment.

11. The ink set of claim 1, wherein one or more of the multiple liquids contain a water-insoluble liquid as a solvent.

12. An inkjet recording ink set comprising the ink set of claim 1.

13. An inkjet image-recording method using the ink set according to claim 1, comprising applying the first and second liquids simultaneously or sequentially in either order onto a recording medium to form an image.

14. The inkjet image-recording method of claim 13, wherein the image is formed by ejecting the second liquid onto the recording medium by an inkjet nozzle simultaneously with, or after application of, the first liquid onto the recording medium.

15. The inkjet image-recording method of claim 13, wherein the application of the first liquid onto the recording medium is carried out by coating using a coating apparatus, and the second liquid is ejected onto the recording medium by an inkjet nozzle after the coating of the first liquid onto the recording medium.

16. The inkjet image-recording method of claim 13, wherein the application of each of the first and second liquids onto the recording medium is carried out by inkjet nozzle ejection.

17. The inkjet image-recording method of claim 13, further comprising fixing the image formed on the recording medium by application of activation energy.

18. The inkjet image-recording method of claim 17, wherein the activation energy is applied by photoirradiation or heating.
